(19) United States
(12) Patent Application Publication
(10) Pub. No.: US 2015/0360759 A1
(43) Pub. Date: Dec. 17, 2015

(54) Safety Device and Inflating Apparatus Therefor

(71) Applicant: Zactill Intellectual Property Pty Ltd, Tingira Heights (AU)

(72) Inventor: David John Ashard, Tingira Heights (AU)

(73) Assignee: Zactill Intellectual Property Pty Ltd, Tingira Heights (AU)

(21) Appl. No.: 14/793,789

(22) Filed: Jul. 8, 2015

Related U.S. Application Data
(63) Continuation-in-part of application No. 13/823,197, filed on Mar. 14, 2013, now abandoned.

(30) Foreign Application Priority Data
Sep. 16, 2010 (AU) 2010904182
Dec. 9, 2010 (AU) 2010905429
Jun. 24, 2011 (AU) 2011902502

(51) Int. Cl. B60C 29/00; G01V 3/08; B63C 9/19; G01L 19/00; B63C 9/105; B63C 9/15

(52) U.S. Cl. CPC B63C 9/24; B63C 9/1055; B63C 9/155; B63C 9/19; G01L 19/00; G01V 3/08

(57) ABSTRACT

An electronically controlled inflating apparatus for inflating an inflatable bladder with inflating product, the inflating apparatus comprising: an actuator which upon activation is adapted to cause the inflatable bladder to be filled with inflating product; a sensor assembly operatively associated with the actuator, the sensor assembly including a first pressure sensor assembly and a second pressure sensor assembly, the actuator adapted to cause inflation of the inflatable bladder responsive to measurements taken by the sensor assembly, and a control module operatively associated with the sensor assembly, the control module including a switch to place the inflating apparatus in an instant activation mode of operation and a swim activation mode of operation respectively, whereby (i) in the instant activation mode the actuator is activated upon the first pressure sensor assembly detecting a first preset pressure, and (ii) in the swim activation mode the actuator is activated upon (a) the second pressure assembly detecting a second preset pressure and (b) a preset time interval is measured by a timer of the control module after the second pressure sensor assembly has detected the second preset pressure.

### FIELD OF THE INVENTION

The invention concerns a safety device, particularly a safety device for keeping a user afloat in a body of water during an emergency situation. The invention further concerns an inflating apparatus for use in such a safety device.

### BACKGROUND OF THE INVENTION

More than a million people die annually as a result of drowning. In the great majority of drowning incidents the victim had no intention of going into the water, but came to be in the water due to an accident, for example being swept from a pier by a large wave or falling off a boat.

As far as water recreational activities are concerned, cruising in small motorised boats ranks high in the list of activities drowning victims were engaged in at the time of drowning. Such drowning incidents frequently occur as a result of boats capsizing or victims falling overboard after a collision with other boats or floating objects. Often victims were unable to reach their lifejackets or became exhausted from treading water before help arrived.

Another factor contributing to the number of drownings at sea is the occurrence of what is referred to as a “rip current” or a “riptide.” A rip current is a strong channel of water which flows seaward from the shore, typically through the surf line. It can occur at any time, causing a swimmer to be taken deep into the ocean. Typically swimmers caught in a rip current will find that they are unable to fight the current, with the result that they have no alternative but to stay afloat for a prolonged period of time while awaiting the arrival of help. Victims of such currents, however, succumb when they become exhausted from treading water before any help can arrive.

A major danger associated with the sport of rock fishing is that of being swept by an unusually large wave while fishing from a rock platform. The main problem confronting a fisherman swept to sea in such a situation is to stay afloat while searching for a suitable place from which to climb out of the water. Many fishermen, however, drown after becoming exhausted from having to tread water for an extended period of time without being able to reach a spot to climb from the water.

In light of the threat of drowning to persons engaging in water recreational activities, various personal flotation devices have been developed. Such devices include, for example, lifejackets having bladders filled with a buoyant material such as foam.

Those lifejackets are, however, cumbersome to wear and are not appropriate for recreational bathers swimming in the surf, or for persons engaging in a range of other types of water recreational activities mostly due to their size, dimensions and how they operate.

Accordingly, there is a need for an inflatable bladder that is not in a permanent state of inflation, as a user's movements in wearing the safety device should be far less impeded than the case with existing lifejackets, which employ a buoyant material such as foam. Furthermore, there is a need to have a sensor assembly which can cause an inflatable bladder to be inflated independent of any intentional prompting by a user and upon contact/detection of water. This ensures that the inflatable bladder inflated even when the user is unconscious, for example, in the case of the user falling overboard and losing consciousness following trauma to the user's head, for example.

Also, there is a need for a safety device that can be used by a swimmer, with an actuator only causing the bladder to become inflated after a predetermined depth under water has been sensed.

There is yet still a need for a switch that enables the inflating apparatus to operate in two distinct modes for different situations. In the first mode, the inflating apparatus, in one example, effectively operates as a swimming garment which can detect whether a swimmer located inside a body of water is in distress and responsive to such determination cause the inflatable bladder to become inflated. In one example, the second mode of operation finds application where a person falls into a body of water and wherein the inflatable bladder is caused to become inflated upon the water sensor detecting the presence of water irrespective of whether a predetermined depth has been sensed by the pressure sensor. In the second mode of operation, for example, the inflatable bladder will be caused to become inflated upon the water sensor detecting water. In the second mode of operation, the inflating apparatus, for example, can act as a personal floatation device, which can be activated within a short period of time after a person has fallen overboard from a moving water vessel or has been swept from a rock by a wave.

Yet further, there is a need for a control module to control, monitor and activate various sensors to ensure the safety of a user, whether conscious or not.

### OBJECT OF THE INVENTION

It is the object of the present invention to substantially overcome or at least ameliorate one or more of the above disadvantages, or to provide a useful alternative.

### SUMMARY OF THE INVENTION

According to a first aspect of the present invention, there is disclosed herein a safety device including:
an article to be worn by a user;
an inflatable bladder which is in use attached to the article; and
an inflating apparatus for in use inflating the inflatable bladder with an inflating product; the inflating apparatus comprising:
an inflating product compartment for storing the inflating product;
a frangible valve for deterring flow of the inflating product from the inflating product compartment; and
an actuator for rupturing the frangible valve to allow inflating product to flow from the inflating product compartment to the inflatable bladder.

According to a second aspect of the present invention, there is disclosed herein an inflating apparatus to be placed in fluid communication with an inflatable bladder, the inflating apparatus comprising:
an inflating product compartment for storing an inflating product;
a frangible valve for deterring flow of the inflating product from the inflating product compartment; and
an actuator for rupturing the frangible valve to allow inflating product to flow from the inflating product compartment, such that in use, inflating product flowing from the inflating product compartment inflates the bladder.

Preferably, the article is a garment or an accessory for attachment to a limb of the user.

Preferably, the garment includes a first attachment formation and the inflating apparatus a second attachment formation in use the first and second attachment formations co-operating to secure the inflating apparatus to the garment.

Preferably, the garment is produced from material having thermal insulation properties for providing thermal insulation to a user immersed in water.

Preferably, the garment is produced from material shielding the user against ultraviolet rays from the sun.

In an embodiment of the invention, the garment is a rash guard.

In another embodiment, the garment is a wetsuit.

Preferably, the garment is produced from spandex, nylon, polyester or neoprene.

Preferably, the garment includes a visibility enhancing coloured section for facilitating enhanced visibility of the user when floating in a body of water material.

Preferably, the colored section is of a fluorescent material.

Preferably, the accessory includes a band for attachment to a limb of the user.

Preferably, the inflatable bladder is produced from rubber, latex or a plastics

Preferably, the inflating apparatus is in use secured to a shoulder portion or a wrist portion of the garment.

Preferably, the inflating apparatus includes a refilling valve through which the inflating product compartment is in use replenished with inflating product.

Preferably, the inflating product is CO₂, liquid nitrogen, hydrogen or a CFC.

Preferably, the safety device includes a conduit for providing fluid communication between the inflating product compartment and the inflatable bladder.

Preferably, the conduit is flexible.

Preferably, the conduit is produced from rubber, a plastics material, silicon or latex.

Preferably, the conduit and/or the inflating apparatus include a fluid permeable barrier.

Preferably, the fluid permeable barrier comprises a mesh.

Preferably, the frangible valve includes one or more zones of weakness.

Preferably, the frangible valve is produced from glass, acrylic resin, copper, polymethyl methacrylate (commonly known as “Perspex®”) or a plastics material.

Preferably, the actuator includes a strap, attached to a rupture member, whereby application of a force to the strap will cause the rupture member to rupture the frangible valve.

In an embodiment, the rupture member is provided by having a portion of the conduit enclose the frangible valve such that in use a force applied to the strap causes the conduit to flex, thereby rupturing the frangible valve.

In another embodiment, the rupture member is produced of a water-expandable material.

Preferably, the inflating apparatus further includes an automated actuator for rupturing the frangible valve.

Preferably, the automated actuator is in communication with a programmable module wherein the automated actuator is activated under control of the programmable module.

Preferably, the programmable module is in electric communication with a sensor assembly wherein the programmable module in use activates the automated actuator responsive to information received from the sensor assembly.

Preferably, the sensor assembly comprises a water sensor, a pressure sensor or both a water sensor and a pressure sensor.

Preferably, the automated actuator comprises an electromagnet and a rupture member.

Preferably, the automated rupture member includes biasing means.

Preferably, the biasing means comprises a spring.

Preferably, the programmable module is in electric communication with a polarity reverse module for changing the polarity of the electromagnet, wherein in use a change in polarity of the electromagnet will cause the rupture member to move under the influence of the biasing means to rupture the valve.

Preferably, the programmable module signals a change in polarity to the polarity reverse module responsive to information received from the sensor assembly.

Preferably, the inflating apparatus includes an information display.

Preferably, the safety device include proximity device.

Preferably, the water-expandable material is water-expandable foam.

Preferably, the safety device includes a non-return valve for deterring inflating product escaping from the inflatable bladder and returning to the inflating product compartment.

Preferably, the safety device includes a plurality inflatable bladders.

Preferably, the safety device includes an auxiliary inflating arrangement whereby a user may use exhaled breath to supplement inflating product in the inflatable bladder.

Preferably, the safety device includes signalling means for in use signalling the location of the user during an emergency situation, typically an Emergency Position Indicating Radio Beacon (EPIRB).

In an embodiment, the signalling means includes lighting means, typically a battery operated light emitting diode (LED).

In an embodiment, the signaling means includes a siren.

In an embodiment, the signaling means includes a GPS unit.

According to a further aspect of the present invention, there is disclosed herein a safety device kit including:
an article to be worn by a user;
an inflatable bladder attachable to the article; and
an inflating apparatus for in use inflating the inflatable bladder with an inflating product; the inflating apparatus comprising:
an inflating product compartment for storing the inflating product;
a frangible valve for deterring flow of the inflating product from the inflating product compartment; and
an actuator for in use rupturing the frangible valve to allow inflating product to flow from the inflating product compartment to the inflatable bladder.

According to a third aspect of the present invention, there is disclosed herein a safety device including:
an article to be worn by a user;
an inflatable bladder which is in use attached to the article; and
an inflating apparatus for in use inflating the inflatable bladder with an inflating product, the inflating apparatus comprising:
an inflating product compartment for storing an inflating product;
a valve assembly for deterring flow of the inflating product from the inflating product compartment;
an actuator for opening the valve assembly to allow inflating product to flow from the inflating product compartment to the inflatable bladder; and
a sensor assembly operatively associated with the actuator, wherein the actuator in use opens the valve assembly responsive to measurements taken by the sensor assembly thereby allowing inflating product to flow form the inflating product compartment.

According to a fourth aspect of the present invention, there is disclosed herein an inflating apparatus to be placed in fluid communication with an inflatable bladder, the inflating apparatus comprising:
an inflating product compartment for storing an inflating product;
a valve assembly for deterring flow of the inflating product from the inflating product compartment;
an actuator for opening the valve assembly to allow inflating product to flow from the inflating product compartment to inflate the inflatable bladder; and
a sensor assembly operatively associated with the actuator, wherein the actuator in use opens the valve assembly responsive to measurements taken by the sensor assembly.

Preferably, the sensor assembly of the third and fourth aspects comprises a water sensor, a pressure sensor or both a water sensor and a pressure sensor.

Preferably, the actuator of the third and fourth aspects comprises a servo motor.

There is further disclosed herein an electronically controlled inflating apparatus for inflating an inflatable bladder with inflating product, the inflating apparatus comprising:
an actuator which upon activation is adapted to cause the inflatable bladder to be filled with inflating product;
a sensor assembly operatively associated with the actuator, the sensor assembly including a first pressure sensor assembly and a second pressure sensor assembly, the actuator adapted to cause inflation of the inflatable bladder responsive to measurements taken by the sensor assembly, and
a control module operatively associated with the sensor assembly, the control module including a switch to place the inflating apparatus in an instant activation mode of operation and a swim activation mode of operation respectively, whereby
   (i) in the instant activation mode, the actuator is activated upon the first pressure sensor assembly detecting a first preset pressure, and
   (ii) in the swim activation mode, the actuator is activated upon (a) the second pressure assembly detecting a second preset pressure and (b) a preset time interval is measured by a timer of the control module after the second pressure sensor assembly has detected the second preset pressure.

Preferably, the first pressure sensor assembly comprises a first and a second pressure sensor.

Preferably, the first and the second pressure sensors are configured such that in the instant activation mode the actuator is only activated upon both the first and the second pressure sensors detecting the first preset pressure.

Preferably, the first and second pressure sensors are first and second pressure switches.

Preferably, the electronically controlled inflating apparatus comprises a motion sensor to detect movement of the electronically controlled inflating apparatus.

Preferably, the control module has a sleep state and an active state and wherein the motion sensor is operatively associated with the control module such that the control module is placed in the active state upon the detection of motion by the motion sensor.

Preferably, the electronically controlled inflating apparatus comprises a water sensing assembly operatively associated with the first pressure sensor assembly and configured to place the first pressure sensor assembly in a standby mode upon the detection of water by the water sensing assembly.

Preferably, the water sensing assembly comprises a first and a second water sensing circuit and wherein the first pressure assembly is only placed in the standby mode upon both the first and second water sensing circuits detecting water.

Preferably, the actuator comprises a servomotor.

Preferably, the inflating product is stored in a cylinder operatively associated with the servomotor and whereby activation of the servomotor causes inflating product to be released from the cylinder to inflate the bladder.

Preferably, the servomotor is attached to a pin which upon activation of the actuator is adapted to pierce the cylinder to release inflating product.

Preferably, the servomotor is attached to a pin which upon activation of the actuator is adapted to open a valve of the cylinder to release inflating product.

Preferably, the actuator upon activation triggers a chemical reaction to produce inflating product.

Preferably, the electronically controlled inflating apparatus comprises a manual activation handle having a manual activation circuit in electrical communication with the actuator, the manual activation circuit being in an open condition until a user applies a pulling force to the manual activation handle, such pulling force causing the activation circuit to be closed so as to activate the actuator.

There is further disclosed herein an electronically controlled inflating apparatus for inflating an inflatable bladder with inflating product, the inflating apparatus comprising:
an actuator which upon activation is adapted to cause the inflatable bladder to be filled with inflating product;
a sensor assembly operatively associated with the actuator, the sensor assembly including a pressure sensor and a second pressure sensor;
a water sensing assembly operatively associated with the first pressure sensor and the second pressure sensor, the water sensing assembly being configured to place the first pressure sensor and the second pressure sensor in a standby mode upon the detection of water by the water sensing assembly,
wherein the actuator is activated after the first and second pressure sensors have been placed in the standby mode and upon the first and second pressure sensors detecting a preset pressure.

### BRIEF DESCRIPTION THE DRAWINGS

Preferred embodiments of the invention will be described hereinafter, by way of examples only, with reference to the accompanying drawings, in which:

FIG. 1 is a schematic representation of a first embodiment safety device;

FIG. 2 is a schematic representation of a first embodiment inflating apparatus for use in the safety device of FIG. 1;

FIG. 3 is a schematic representation of a second embodiment safety device;

FIG. 4 is a schematic representation of a portion of a third embodiment inflating apparatus;

FIG. 5 is a schematic representation of a fourth embodiment inflating apparatus;

FIG. 6 is a schematic representation of a portion of a fifth embodiment inflating apparatus;

FIG. 7 is a schematic representation of a container for use in another embodiment safety device;

FIG. 8 is a schematic representation of a controller for use with the container of FIG. 7;

FIG. 9 is a schematic representation of a safety device of another embodiment safety device;

FIG. 10 is a schematic representation of a container for use in the safety device of FIG. 9;

FIG. 11 is a schematic representation of another safety apparatus;

FIG. 12 is a further schematic representation of the safety apparatus of FIG. 11; and

FIG. 13 is a schematic representation of a portion of an alternative bladder for use in another embodiment safety apparatus;

FIG. 14 is a schematic representation of another embodiment safety apparatus;

FIG. 15 is a flow chart of a toddler safety device embodiment of the present invention showing the system not activated;

FIG. 16 is a flow chart of the toddler safety device embodiment of the present invention of FIG. 15 activated;

FIG. 17 is a flow chart of a Duo safety device embodiment of the present invention showing the system in swim mode and not activated;

FIG. 18 is a flow chart of the Duo safety device of FIG. 17 shown activated;

FIG. 19a is a flow chart of the Duo safety device embodiment of the present invention shown in the swim mode and activated manually;

FIG. 19b shows embodiment of a pull code for the manual operation shown in FIG. 19a.

FIG. 20 is a flow chart of the Duo safety device embodiment of the present invention shown in instant mode and not activated;

FIG. 21 is a flow chart of the Duo safety device embodiment of the present invention shown in instant mode and where activated;

FIG. 22 is a flow chart of the duo safety device of an embodiment of the present invention shown in swim mode and the system activated;

FIG. 23 is a flow chart of the duo safety device shown in swim mode where there is no activation;

FIG. 24 is a flow chart of the safety device shown in instant mode with the system of the present invention activated;

FIG. 25 is a flow chart of the safety device of an embodiment of the present invention shown in instant mode and the system not activated;

FIG. 26 is a flow chart of the safety device toddler embodiment and where the system is shown activated;

FIG. 27 is a flow chart of the safety device toddler embodiment shown with no activation;

FIG. 28 is an embodiment of an actuation canister for use with the present invention;

FIG. 29 is an embodiment of an actuation canister for use with the present invention;

FIG. 30 is a servo motor housing unit for use with the present invention;

FIG. 31 is a servo motor housing it with D-valve for use with the present invention;

FIGS. 32(a)-(b) are front and side views of a servo motor housing unit with D-valve for use with the present invention;

FIGS. 33(a)-(b) are front and side views of a servo motor housing unit for use with the present invention;

FIG. 34 is a servo motor housing unit for use with the present invention;

FIG. 35 is a servo motor housing unit with D-valve for use with the present invention;

FIGS. 36(a)-(b) are front and side views of a servo motor housing unit with D-valve for use with the present invention;

FIGS. 37(a)-(b) are front and side views of a servo motor housing unit with D-valve for use with the present invention;

FIG. 38 is an exertion pin retro-fit for use with the present invention;

FIGS. 39(a)-(b) show an exertion pin retro-fit in a first and a second position for use with the present invention;

FIGS. 40, 41, 42(a)-(b), and 43(a)-(b) show a rotating ball valve depression pin for use with the present invention;

FIG. 44 shows a connection to a gas canister; and

FIGS. 45(a)-(c) show internal views of FIG. 44.

### DESCRIPTION OF PREFERRED EMBODIMENTS

In the description that follows below, like reference numerals will be used to indicate like components. The examples and drawings provided in the detailed description are merely examples, and should not be used to limit the scope of the claims in any claim construction or interpretation.

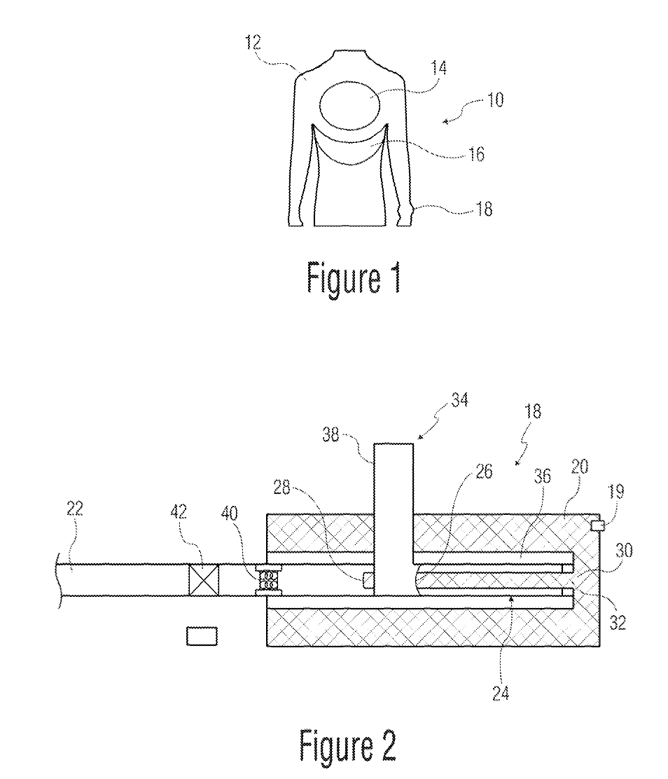

FIG. 1 shows a first embodiment of a safety device, generally indicated with the reference numeral 10. In use, the safety device 10 serves to keep a user afloat in a body of water during an emergency situation, for example, in the case of the user having fallen overboard from a sea vessel.

The safety device 10 includes an article to be worn by a user, here in the form of a garment 12, specifically a rash guard. The garment 12 of this embodiment is produced from polyester. Polyester is suitable as it firstly provides thermal insulation to the user while immersed in water and secondly provides protection against ultraviolet rays from the sun.

The garment 12 further includes a visibility enhancing coloured section 14, produced from a fluorescent material. In use the coloured section provides enhanced visibility of the user floating in a body of water. This feature serves to assist rescue teams in spotting the user while they search a particular body of water.

An inflatable rubber bladder 15 is secured to a torso region of the garment 12. The safety device 10 also includes an inflating apparatus 18. The inflating apparatus 18 includes an inflating product compartment 20, shown in FIG. 2, for holding an inflating product for, in use, inflating the inflatable bladder 16 during an emergency situation. The inflating apparatus 18 is secured to a wrist portion of the garment 12 as shown. The inflating apparatus 18 could, of course, be attached to a number of positions on the garment 12. The specific location of the inflating apparatus 18 on the garment 12, however, will be a function of where it will interfere least with the recreational activities in which the user will engage when in the water.

The inflating product compartment 20 holds inflating product in the form of CO2. A schematic representation of the first embodiment inflating apparatus 18 is provided in FIG. 2. The inflating apparatus 18 firstly includes the inflating product compartment 20 in which the inflating product is stored. The inflating apparatus 18 further includes a refilling valve 19 through which the inflating product compartment 20 can be replenished with inflating product.

The inflating apparatus 18 is placed in fluid communication with the inflatable bladder 15 via a rubber conduit 22. The inflating product is, however, prevented from flowing from the inflating product compartment 20 to the inflatable bladder 16 until a frangible valve, generally indicated by the reference numeral 24, is ruptured as discussed below. Upon the frangible valve 24 being ruptured, the inflating product is allowed to flow from the inflating product compartment 20 of the inflating apparatus 18, through the conduit 22 and to the inflatable bladder 16.

The frangible valve 24 comprises a tubular glass body 26. The tubular body 26 has a closed end 28 and an open end 30 placed in fluid communication with a mouth 32 of the inflating product compartment 20. The connection between the inflating product compartment 20 and the tubular body 26 is such that no inflating product escapes at the interface of the open end 30 and the mouth 32. Further, the closed end 28 of the tubular body 26 deters the flow of inflating product from the inflating product compartment 20 into the conduit 22.

The inflating apparatus 18 includes an actuator 34 for rupturing the valve 24. The actuator 34 firstly comprises a rupture member 36, here provided in the form of a portion of the flexible conduit 22 which encloses the tubular body 26 as shown. The actuator 34 further includes a strap 38 which is at its one end wound about the rupture member 36.

In an emergency situation, for example where the user has fallen overboard, the user pulls on the strap 38, thereby exerting a force on the strap. This force causes the rupture member 36 to flex. Such flexing, in turn, imparts a bending moment on the tubular body 26 of the frangible valve 24. Continued flexing of the rupture member 36 causes the tubular body 26, and as a result the frangible valve 24 to rupture. Rupturing of the frangible valve 24, in turn, allows the inflating product to escape the inflating product compartment 20 via the conduit 22 resulting in the bladder 16 becoming inflated.

It will be understood that rupturing of the frangible valve 24 results in the conduit 22 being filled with shards of glass. To deter such shards being fed to the inflatable bladder 16, the conduit 22 includes a fluid permeable barrier 40 in the form of a mesh.

Further, to enable disconnection of the inflating apparatus 18 from the conduit 22, the conduit includes a connector formation 42, here a quick-release connector. A snap-lock connector can also be employed.

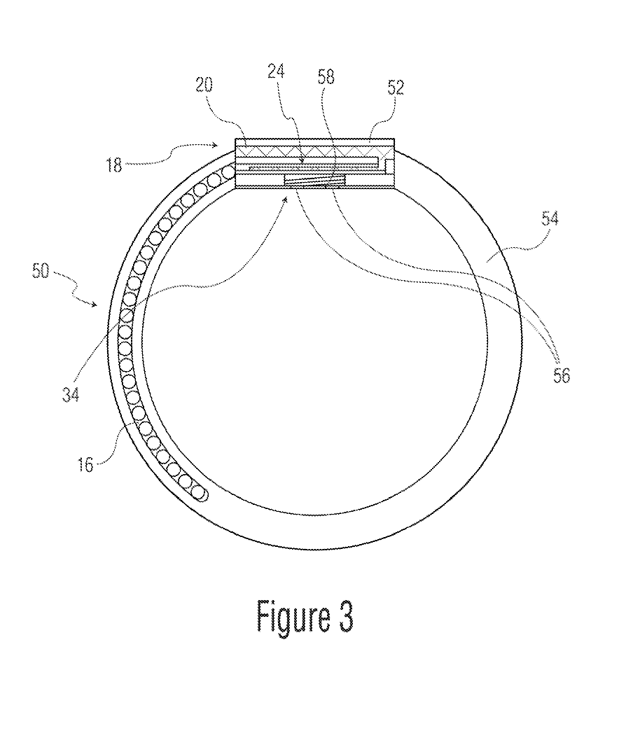

In a second embodiment of a safety device, indicated with the reference numeral 50 in FIG. 3, the article to be worn by a user is provided in the form of an accessory, having a watch 52, which can be attached to a limb of the user. The safety device 50 further includes a band 54 which can extend around a limb of the user.

The safety device 50 also includes an inflating apparatus 18 for storing an inflating product in an inflating product compartment 20. Here, however, the inflating apparatus 18 includes a number of holes 56, the purpose of which will become apparent from the description which follows.

The safety device 50 also includes a frangible valve 24 housed within the inflating apparatus 18.

The safety device 50 further includes an inflatable bladder 16 which is secured to outer surface of the band 54.

Unlike the safety device 10, the actuator 34 of the safety device does not include a strap. Rather, the actuator 34 includes a water-expandable material 58 comprising water-expandable compressed foam. In an emergency situation, for example where a user 35 has fallen from a sea vessel, water enters the inflating apparatus 18 through the holes 56.

The water-expandable foam 58 will absorb such water, thereby being caused to expand. Continued expansion of the foam 58 will cause the frangible valve 24 to be ruptured in a manner similar to that of the safety device 10. Upon rupture of the frangible valve 24, inflating product flows from the inflating product compartment 20 to inflate the bladder 16.

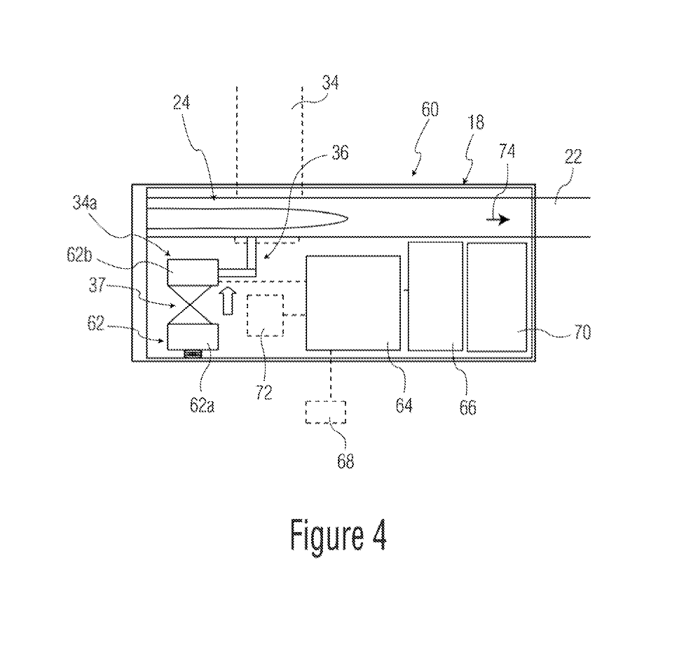

FIG. 4 shows a portion of a third embodiment inflating apparatus 60. The inflating apparatus 60 includes an automated actuator 34a having a rupture member 36. The automated actuator 34a includes a magnet 62 in electric communication with a programmable module 64, the programmable module having a polarity reverse module.

The automated actuator 34a also includes biasing means, here in the form of a spring 37. The rupture member 36 is placed proximate a frangible valve 24 located within a flexible conduit 22. The conduit 22 is in fluid communication with a non-illustrated inflatable bladder.

The inflating apparatus 60 includes a battery power source 66, here a nickel-cadmium battery, for driving electronic components of the inflating apparatus, an information display 68 and a proximity device 70, the purpose of which is discussed below. In order to activate the automated actuator 34a, the inflating apparatus 60 includes a sensor assembly 72, here in the form of an electronic water sensor, to detect when the safety device has been immersed in water.

The magnet 62 comprises first and second magnetic components 62a and 62b, the first magnetic component 62a comprising an electromagnet and the second magnetic component 62b comprising a permanent magnet. In “non-wet” conditions the magnetic components 62a and 62b have opposite polarities resulting in those components being attracted to one another and located in a non-illustrated first position wherein they are located adjacent one another. With the magnetic components 62a and 62b in the first position a compressive force is applied to the spring 37 causing it to become biased. The magnitude of the magnetic force holding the components 62a and 62b are of sufficient strength to deter the spring 37 from pushing them apart.

Upon the water sensor 72 being immersed in a body of water, an electronic signal 30 is communicated to the programmable module 64. Upon receipt of a signal informing that the water sensor 72 has detected water, the polarity reverse module is activated to cause the polarity of the first magnetic component 62a to be reversed. As the magnetic components now have similar polarities, they repel one another. Accordingly, as the force biasing the spring 37 is removed, the spring will return to its unbiased state. Due to the fact that the spring 37 was located in a biased condition, return of the spring to an unbiased state causes the second magnetic component 62b and, as a result, the rupture member 36 to undergo an amount of acceleration. Due to the position of the rupture member 36 relative to the frangible valve 24, the subsequent momentum of the rupture member causes it to impact upon the conduit 22, such impact resulting in the conduit flexing. Flexing of the conduit 22, in turn, ruptures the frangible valve 24, thereby allowing inflating product to escape the inflating product compartment of the inflating apparatus 60. The inflating product now flows in the direction of the arrow 74, thereby inflating the bladder.

The inflating apparatus 60 includes another actuator 34, provided in the form of a strap which operates on similar principles to the strap of the first embodiment safety device described above.

The programmable module 64 is pre-programmed to provide a number of modes of operation, those being: (i) a safe mode, (ii) an off mode, (iii) a remote mode, (iv) a manual mode and (v) a proximity mode.

In the safe mode, the safety device will cause the frangible valve 24 to be ruptured upon the water sensor 72 detecting the presence of water. Ithe off mode a user is allowed to swim and the water sensor 72 will not trigger rupturing of the frangible valve 24. However, should the user find himself/herself in distress, the actuator 34 can still be used to rupture the frangible valve 24 in order to inflate the bladder. In the remote mode, a user can also swim without the valve being ruptured. The programmable module, however, includes a receiver module for receiving signals from a remote signalling means. That mode thus allows, for example, a child to swim and a parent to cause the valve to be ruptured when the child is in distress. Rupture is achieved by the parent activating a remote signalling means to communicate with the programmable module via the receiving module.

The proximity mode operates via the proximity device 70 and serves as signalling means to alert an operator that the user of the safety device has moved beyond a set distance from a remote device held by the operator. That mode can, for example, be employed to alert parents inside a house that a child playing outside has moved outside a set range. The parent can then take appropriate action to ensure the safety of the child.

As mentioned above, the safety device includes an information display 68. In this embodiment, provided in the form of a number of non-illustrated light emitting diodes (LEDs). The LEDs in use serve, for example, to indicate (i) the selected mode of the safety device, (ii) low battery charge and (iii) low levels of inflating product within the inflating product compartment. The remote signalling means may also include indicating means to alert an operator that the valve has been ruptured and that the user of the safety device may be in distress.

Although not illustrated, the safety device to be attached to the inflating apparatus 60 also includes an auxiliary inflating arrangement whereby a user may use his breath to supplement its inflatable bladder. The user could also inflate the bladder via the auxiliary inflating arrangement, should the inflating apparatus malfunction and fail to inflate the bladder.

FIG. 5 shows a fourth embodiment of the inflating apparatus 78. The inflating apparatus 78 is similar in operation to the above described embodiments in that it includes a frangible valve 24 and an inflating product compartment 20 for holding inflating product. The inflating apparatus 78 also includes an actuator 34 whereby a force exerted thereon by a user will rupture the frangible valve 24 to allow inflating product to flow from the inflating product compartment 20 via a conduit 80 into an outlet conduit 82. A mesh 40 is provided for deterring shards of the ruptured valve 24 from being fed into the conduit 80. The outlet conduit 82 is sealed-off with a seal 84 when not in use. In use the outlet conduit 82 is connected to a non-illustrated conduit, the conduit being in fluid communication with a bladder, via a conventional snap-lock connector.

The inflating apparatus 7 includes two holding compartments 86 and 88 which are sealed with water sealing caps 90 and 92. The first holding compartment 86 houses an electronic module 94 which includes a proximity sensor, an Emergency Position Indicating Radio Beacon (EPIRB), an electronic water sensor, a mechanical water pressure sensor with a countdown timer, a low battery alarm, a remote activation function, a service alert and a sensor activation function. The electronic module 94 is powered by a battery 96 housed within the second holding compartment 88. A further battery 98 is housed within a sealed chamber 97, and acts as a back-up for the battery 96.

A strap 100 on the actuator 34 includes a switch 102 for activating and de-activating the electronic module 94.

The inflating apparatus 78 differs from the above described embodiments in that it includes an automated actuator 34b which comprises a servo motor. The servo motor 34b is powered by the battery 98.

As shown, the servo motor 34b is attached to a valve assembly 104. The valve assembly includes a valve 103, for locating inside a seat 105, a pin 106 and a release 108.

The valve assembly 104 serves to deter inflating product from leaking from the inflating product compartment 20 into the chamber 97 and into the outlet tube 82.

The pin 106 is attached to the servo motor 34b. Upon activation of the servo motor 34b, the valve 103 will be extracted from its sealing position while the pin 106 will cause the release valve 108, here in the form of a Schrader valve, to be depressed, allowing inflating product to flow to the outlet conduit 82 via the chamber 97. Thus, the actuator 34b will cause inflating product to flow to the bladder without destruction of the frangible valve.

A filling valve 110 is provided for replenishing the inflating product compartment 20 with inflating product. The filling valve 110 is accessed when the sealed chamber 97 is opened by removing a cover 21.

A feature of the frangible valve 24 is that it is transparent and acts as a sight glass to enable a user to view the level of a coloured inflating product in order to determine whether the inflating product compartment 20 requires replenishment.

Activation of the servo motor 34b occurs responsive to activation parameters being detected by a non-illustrated sensor assembly comprising a proximity sensor, an electronic water sensor and/or a mechanical water pressure sensor.

Activating the inflating apparatus 78 via the switch 102 will, for example, enable the electronic water sensor to activate the servo motor 34b upon the water sensor detecting water. However, if the inflating apparatus 78 is de-activated by the switch 102, the mechanical pressure sensor will still activate the inflating apparatus 78. This will occur if a predetermined depth under water is detected. Upon detection of the predetermined depth, the countdown timer is activated. As soon as the timer reaches a set time interval, the servo motor 34b is activated, allowing inflating product to flow through the outlet conduit 82, as discussed above, to an inflatable bladder of a safety device.

Should the user, however, resurface before lapsing of the set time interval, the countdown timer will reset itself to deter the bladder from being inflated.

One application in which the proximity sensor of the inflating apparatus may find application is when a dockworker enters a specific area, for example a wharf area, where a signal can be communicated to the proximity device, allowing it to activate the inflating apparatus. However, once the dockworker exits the wharf area, the proximity sensor will cause the inflating apparatus to be deactivated. Of course, the mechanical pressure sensor will still cause inflating product to be released to an inflatable bladder, if the dockworker was to fall into the water with the inflating apparatus in a deactivated state.

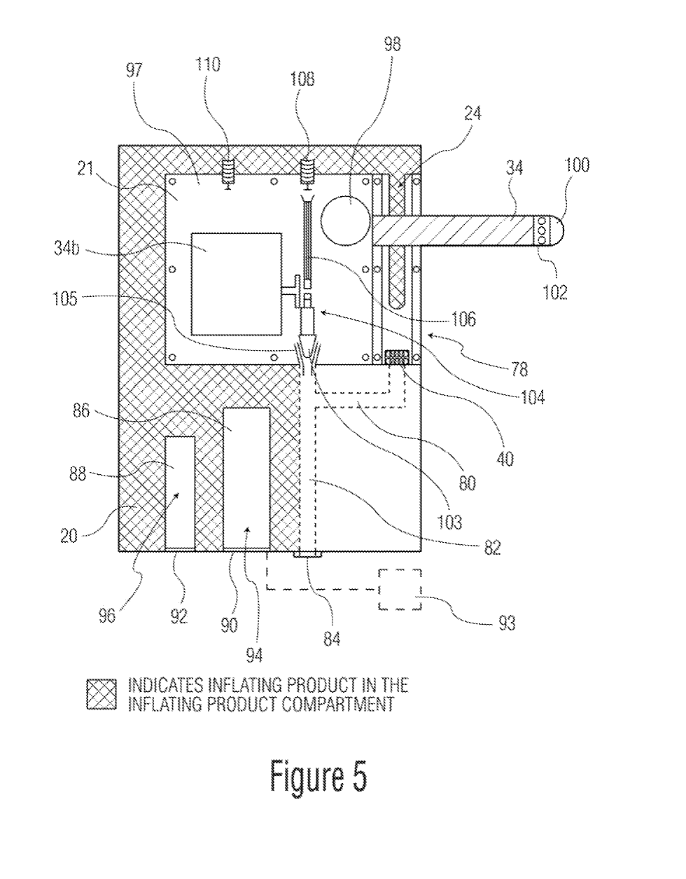

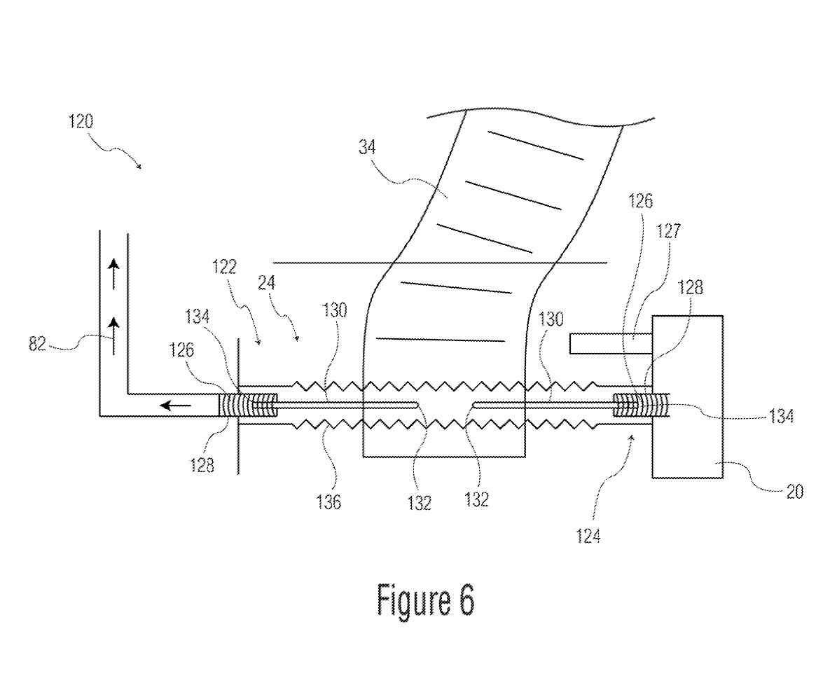

FIG. 6 shows a schematic representation of a portion of a fifth embodiment inflating apparatus 120. The frangible valve 24 of the inflating apparatus 120 comprises two valve members 122 and 124, each having a threaded portion 126 to engage corresponding threaded sections 128 of the inflating apparatus 120. Each valve member 122 and 124 comprises a frangible tube 130 of polymethyl methacrylate. Each tube has a closed end 132 and an open end 134. The open end of each tube 130 is secured within one of the threaded portions 126 with a suitable adhesive. The adhesive serves to seal the tubes 130 within the valve members 122 and 124 so that a fluid cannot pass between the outside wall of the tubes and inner surfaces of the valve members 122 and 124.

The tubes 130 are enclosed within a rubber conduit 136 to provide for fluid communication between the inflating product compartment 20 and the outlet tube 82. The rubber conduit 136 has a concertina shape which facilitates ease of assembly by providing that the conduit can be manipulated to be put in place when the frangible tubes 130 are in position.

An actuator strap 34 is provided for flexing the conduit 136 to rupture the tubes 130 thereby allowing inflating gas to flow from the inflating product compartment 20 through the conduit 136 to the outlet tube 82 from where it is fed to an inflatable bladder.

The inflating apparatus 120 further includes a sight glass 127 by which a user can determine whether the apparatus is to be replenished with inflating product.

In a sixth non-illustrated embodiment, the safety device 10 includes a container. The container includes a tube by which a user can extract liquid held in the container. Typically the container will be secured to the garment, preferably the back of the garment.

In a seventh non-illustrated embodiment, the safety device includes a signalling means for signally the location of the user during an emergency situation. Examples of signalling means include lighting means, typically a battery operated LED, a siren or GPS signalling unit wetsuit.

In a non-illustrated embodiment, the garment is produced from spandex, nylon or neoprene rubber.

In a non-illustrated embodiment, the inflatable bladder is produced from latex or a plastics material.

In a non-illustrated embodiment, the safety device includes a plurality of inflatable bladders to ensure that the safety device keeps the user afloat despite one or more of the inflatable bladders becoming punctured while the user awaits rescue.

In a non-illustrated embodiment, the inflating product is liquid nitrogen or CFC.

In a non-illustrated embodiment, the frangible valve includes one or more zones of weakness.

In a non-illustrated embodiment, the frangible valve is produced from a thermoplastic acrylic resin, commonly sold under the trade name Perspex,® or in the U.S., under the trade name Plexiglas®. The trade name Plexiglas is currently owned by Arkema France Corporation 420 rue d'Estienne d'Orves 92700 Colombes France, while the original registrant was Rohm and Haas Corporation, Independence Mall, West Philadelphia, Pa., U.S.A. 19105.

In a non-illustrated embodiment, the frangible valve includes a copper body including one of more scored sections for providing zones of weakness.

In a non-illustrated embodiment, there is provided a safety device kit which can, for example, be retrofitted to a rash guard. The kit includes an inflatable bladder, which can be secured to the rash guard, and an inflating apparatus as discussed above.

Further, the kit also includes an attachment arrangement for facilitating attachment of the safety device to a user, for example, a clipping arrangement whereby the safety device can be attached to a garment worn by the user.

In a non-illustrated embodiment, the inflatable bladder includes a non-return valve to deter inflating product from escaping the inflatable bladder and returning to the inflating product compartment.

In a non-illustrated embodiment, the accessory includes a compass.

In a non-illustrated embodiment, the inflating product is hydrogen.

In a non-illustrated embodiment, the inflating apparatus is secured to a shoulder portion of the garment.

In a non-illustrated embodiment, a water sensor is provided that can be connected to a neck portion of a garment worn by a user, the sensor being in electrical communication with the inflating apparatus. In use the water sensor will cause the inflating apparatus to be activated when the water sensor detects the presence of water on the neck portion of the garment.

In a non-illustrated embodiment, the frangible valve and/or conduit is produced from a plastics material.

In a non-illustrated embodiment, the safety device includes an auxiliary inflating arrangement whereby a user may use his breath to supplement the inflating product in the bladder. The auxiliary inflating arrangement includes a blow tube having a non-return valve.

It will be appreciated that a safety device can be constructed with different combinations of the above described valves and actuators. The frangible valve of FIG. 6 can for example be employed in the inflating apparatus of FIG. 5 instead of the frangible valve shown therein.

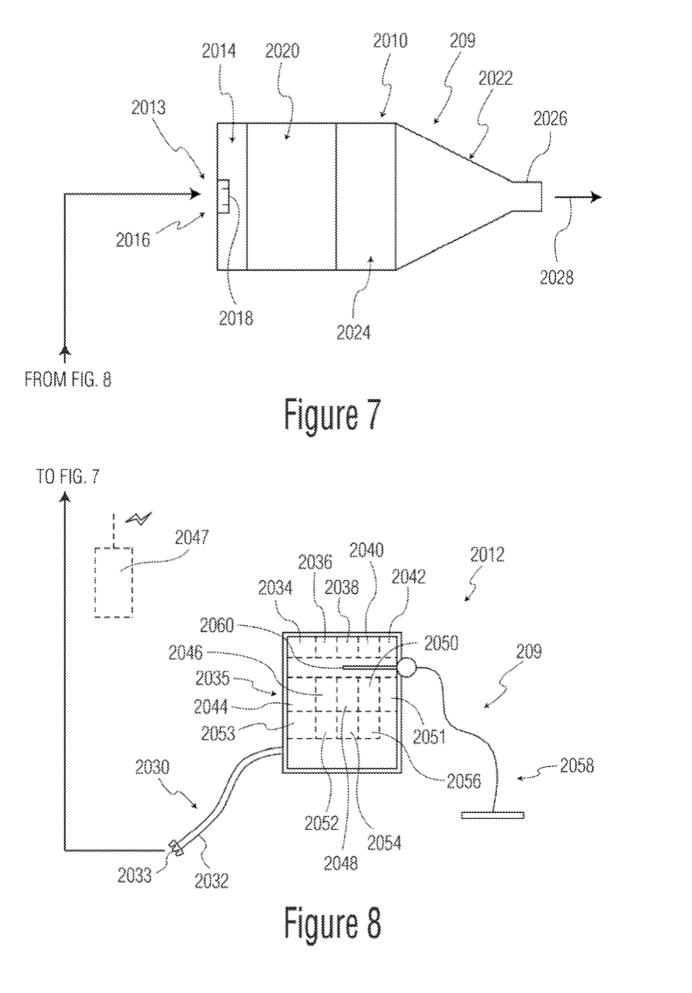

FIG. 7 and FIG. 8 respectively illustrate a container 2010 and a controller 2012 of another embodiment safety device 209. In use, the safety device 209 will be coupled to a non-illustrated inflatable bladder. During an emergency situation during which a user is immersed in a body of water, for example in the case of the user having fallen overboard from a sea vessel, the safety device 209 will cause the bladder to be inflated so as to keep the user afloat until the user is rescued or manages to swim to safety. The safety device 209 will in use typically be attached to an article worn by a user, for example a rash guard.

The container 2010 is adapted to house a chemical reaction during which an inflating product is produced. In an embodiment the container 2010 holds sodium azide (NaN₃). When the sodium azide is caused to react, nitrogen gas (N₂) will be produced. The nitrogen gas is then employed as an inflating product as is discussed below.

The container 2010 includes a compartment 2014 having an electronic socket 2016. The electronic socket 16 is in electronic communication with an actuator having an igniter 2018.

The container 2010 further includes an expansion compartment 2020. The container 2010 further includes a nozzle 2022 which is in fluid communication with the expansion compartment 2020 via a filter 2024.

The container 2010 is generally tubular in shape. It will, however, be appreciated that the container 2010 can have different shapes such as square tubular, rectangular tubular or hexagonal. The container 2010 is produced from aluminium. It will of course be understood that the container 2010 could be produced from other materials such as steel, plastic, brass or ceramic.

The nozzle 2022 has a mouth 2026 adapted to be coupled to a non-illustrated conduit which in turn is in use coupled to the non-illustrated inflatable bladder. In an emergency situation the conduit will direct inflating product from the container 2010 in the direction of arrow 2028 towards the inflatable bladder.

The controller 2012 is connectable to the container 2010 through a communication assembly 2030. In this embodiment, the communication assembly 2030 comprises an electric cable 2032. The cable 2032 at one end includes a plug 2033 which is adapted to couple with the electronic socket 2016 of the container 2010. It will be understood that the communication assembly 2030 could be provided by alternative means, for example by wireless, Bluetooth™ or infrared connectivity. The container 2010 and the controller 2012 could also be physically coupled to obviate the need for such a communication assembly.

The controller 2012 includes a sensor assembly 2035. In use the controller 2012 is adapted to generate an activation signal responsive to measurements taken by the sensor assembly 2035 when indicating that the user is in distress.

The sensor assembly 2035 includes a proximity sensor 2034, signalling means comprising an Emergency Position Indicating Radio Beacon (EPIRB) and a Global Position System (GPS) module 2036, an electronic water sensor 2038, a mechanical water pressure sensor 2040 in communication with a countdown timer 2042, a low battery alarm 2044, a remote activation module 2046, a service alert module 2048 to provide indication that the safety device is due for a routine service (typically in 2012 month intervals), a sensor activation module function 2050, a heart monitor sensor 2051 to monitor the heart rate of a user as well as a breathing sensor 2053 to monitor the breathing of the user. The controller 2012 is powered by a rechargeable main battery 2052. A second rechargeable battery 2054 is provided to serve as a back-up for the main battery 2052 should the latter be rundown or far some reason fail. That is, in a preferred form, there are three batteries that work to support each other if one runs low, the three batteries being recharged simultaneously.

The container 2010 includes an actuator 2013 that is in use adapted to trigger a chemical reaction that will produce inflating product. The actuator 2013 comprises the compartment 2014, electronic socket 2016 and igniter 2018. Upon the controller 2012 generating an activation signal the igniter 2018 will ignite the sodium azide in the compartment 2014. Hereafter the reaction will spread to the expansion compartment 2020. The reaction of the sodium azide will produce nitrogen gas. The nitrogen gas is fed through the filter 2024, here a mesh filter, to the nozzle 2022 from where the nitrogen gas is fed to the non-illustrated inflatable bladder. The filter 2024 will serve to absorb heat generated by the expansion of the sodium azide and will also prevent particles being fed to the bladder.

The controller 2012 is pre-set to provide a number of modes of operation, those being: (i) a safe mode, (ii) an off-mode, (iii) a remote mode, (iv) a manual mode and (v) a proximity mode.

In the safe mode, the controller 12 will generate an activation signal upon the water sensor 38 detecting the presence of water. In the off-mode, a user is able to swim and the water sensor 38 will not trigger an activation signal.

In the remote mode, a user is able to swim without the controller 2012 generating an activation signal. The remote activation module 2046 is adapted to receive signals from a remote signalling means 2047. The remote activation module 2046 thus allows, for example, a child to swim and a parent to cause the chemical reaction to be triggered when the child is in distress. An activation signal is achieved by the parent activating the remote signalling means 2047 to communicate with the controller 2012 via the remote activation module 2046. In this embodiment, the remote activation module 2046 comprises mobile telephony circuitry, such as a subscriber identification module (SIM) card that is adapted to communicate with a mobile telephone providing the remote signalling means 2047. In use a parent can generate an activation signal by remotely communicating with the remote activation module 2046.

The mobile telephone 2047 will typically include application software to operate in conjunction with the safety device 209. The software may be adapted to provide information on the location of the safety device 209 and to generate an alarm signal to indicate that an emergency situation has arisen indicated by the fact that an activation signal has been generated.

The proximity mode operates via the proximity sensor 2034 and serves as signalling means to alert an operator that the user of the safety device 209 has moved beyond a set distance from a remote device, here a mobile telephone, held by the operator. That mode can, for example, be employed to alert a parent inside a house that a child playing outside has moved outside a set range. The parent can then take appropriate action to ensure the safety of the child.

The controller 2012 includes an information display module 2056. In this embodiment, provided in the form of a number of non-illustrated light emitting diodes (LEDs). The LEDs in use serve to indicate (i) the selected mode of the safety device, (ii) a low battery charge, (iii) potential low levels of inflating product within the inflating product compartment and (iv) service due alerting the user that the safety device must undergo a scheduled service. The remote activation module 2046 may also include indicating means to alert an operator that an activation signal has been generated and that the user of the safety device 209 may be in distress. Similarly, the information display module 2056 may include an alarm to alert third parties that the user of the safety device 209 is in distress. The alarm can be provided in the form a speaker to generate a siren and/or a light emitting device to generate a flashing light to signify distress.

A pull cord 2058 is provided and is attached to a pin 2060 as shown. The pin 2060 is adapted to co-operate with non-illustrated circuitry of the controller 2012 in such a manner that removal of the pin 2060 from the controller 2012 by a user pulling on the pull cord 2058 will short-circuit the circuitry to cause an activation signal to be generated so that the chemical reaction will be caused to take place. In an alternative arrangement, pulling on the pull cord 2058 will close a switch to cause an activation signal to be generated.

To recharge the batteries 2052 and 2054, the controller 2012 includes a recharge socket, not illustrated, which is adapted to be coupled to a charging unit connectable to an electricity supply. It is adapted to recharge all batteries simultaneously.

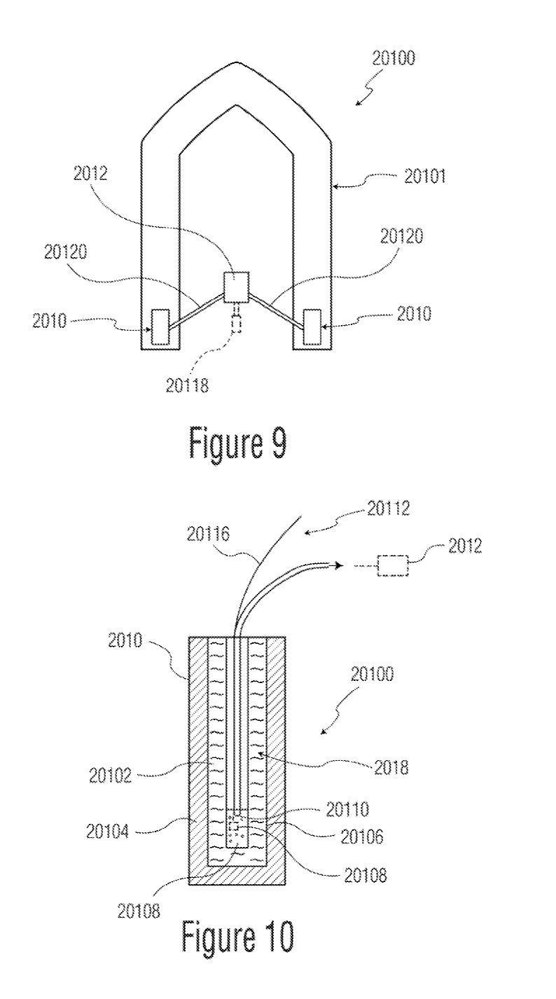

A second embodiment safety device 20100 is shown in FIG. 9 and FIG. 10. The safety device 20100 includes two containers 2010 adapted to house a chemical reaction during which an inflating product is to be produced for inflating an inflatable bladder 20101. Each container 2010 of the safety device 100 further comprises an actuator 2018 adapted to trigger the chemical reaction within the containers 2010. A controller 2012 is in communication with each actuator 2018. The controller 2012 includes a non-illustrated sensor assembly. In use the controller 2012 is adapted to generate an activation signal responsive to measurements taken by the sensor assembly as discussed above. The actuators 2018 are adapted to trigger the chemical reaction responsive to the activation signal generated by the controller 2012 as is discussed below.

Each container 2010 comprises a first compartment 20102 and a second compartment 20104 respectively for housing a first and a second substance that is to take part in the chemical reaction. The first and second compartments are separated by a barrier 20106.

In this embodiment, the first substance is a reactant, specifically hydrogen peroxide (2H₂O₂) and the second substance is a catalyst, specifically potassium permanganate (KMnO₄) or manganese dioxide (MnO₂).

Each actuator 2018 includes a pyrotechnic composition 20108, here, a flash powder, and an igniter 20110 for igniting the pyrotechnic composition. In an emergency situation, ignition of the pyrotechnic composition will rupture the barrier 20106 to allow the first and second substances to react to produce the inflating product.

With the reactant being hydrogen peroxide (2H₂O₂), water and inflating product in the form of oxygen (O₂) will be produced. By employing 2068 grams hydrogen peroxide and about 2 grams of potassium permanganate (KMnO₄) or manganese dioxide (MnO₂) as catalyst, approximately 22 litres of oxygen will be generated according to the formula:

2H₂O₂→2H₂O+O₂

The safety device 20100 includes a manual actuator 20112 having a piezoelectric igniter 20114 adapted to ignite the pyrotechnic composition. The piezoelectric igniter 20114 is attached to a pull cord 20116. The piezoelectric igniter 20114 is adapted to ignite the pyrotechnic composition responsive to a force applied to the pull cord 20116 by a user.

In a further embodiment, the first and second substances respectively are first and second reactants that react to produce the inflating product. Specifically the first reactant is sodium bicarbonate (NaHCO₃) and the second reactant hydrogen chloride (HCl). Those reactants will react to produce sodium chloride, water and carbon dioxide (the inflating product) according to the following formula:

NaHCO₃+HCl→NaCl+H₂O+CO₂

By using about 84 grams sodium bicarbonate (NaHCO₃) and 36 grams reactant hydrogen chloride (HCl) approximately 22 litres of carbon dioxide (CO₂) will be produced.

The controller 2012 of this embodiment includes an external battery pack 20118. The controller 2012 is further connected to the two containers 2010 via cables 20120 which pass through non-illustrated sealable zip fasteners in the inflatable bladder 20101.

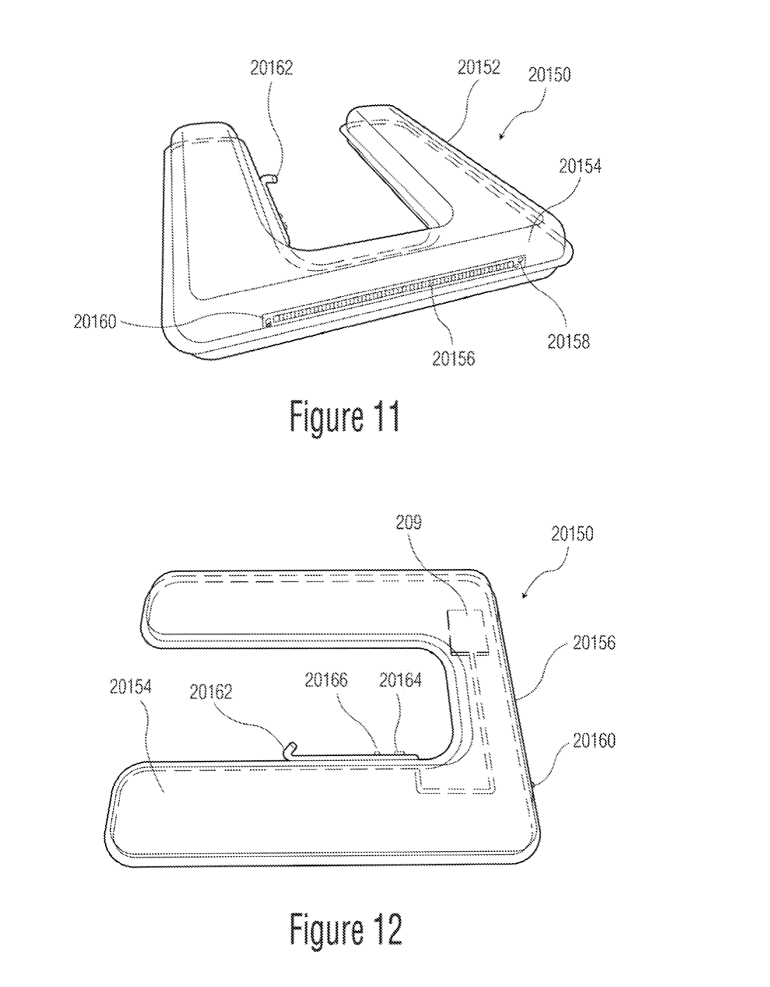

FIG. 11 shows an embodiment safety apparatus, generally indicated with the reference numeral 20150. The safety apparatus 20150 includes an inflatable bladder 20152 of an inflatable vest. The bladder 20152 defines an inner volume 20154. Located within the inner volume 20154 is a safety device 209. To provide access to the inner volume 20154, for example to replace the safety device 209, the bladder 20152 includes a sealable closure 20156. In this embodiment, the sealable closure comprises a pressure zip fastener.

The safety device 209 further includes a water sensor 20158 exterior of the inner volume 20154 to detect when the bladder 20152 is immersed in water as well as a pressure sensor 20160, also exterior of the inner volume 20154, to sense water pressure when the bladder is immersed in a body of water. The safety device 209 operates in a manner as described above and will cause the bladder 20152 to become inflated with inflating product responsive to measurements taken by the water sensor 20158 and the pressure sensors 20160.

The safety apparatus 20150 further includes an oral inflator 20162 whereby a user can supplement inflating product in the bladder 12052 with breath as well as an on/off switch 20164 for activating and deactivating the safety device 209. To charge a battery of the safety device 209 an external charge port 20166 is provided.

By enclosing the safety device 209 and its electronic circuitry within the bladder 20152 as discussed above, they are protected against the corrosive effects of water, particularly salt water.

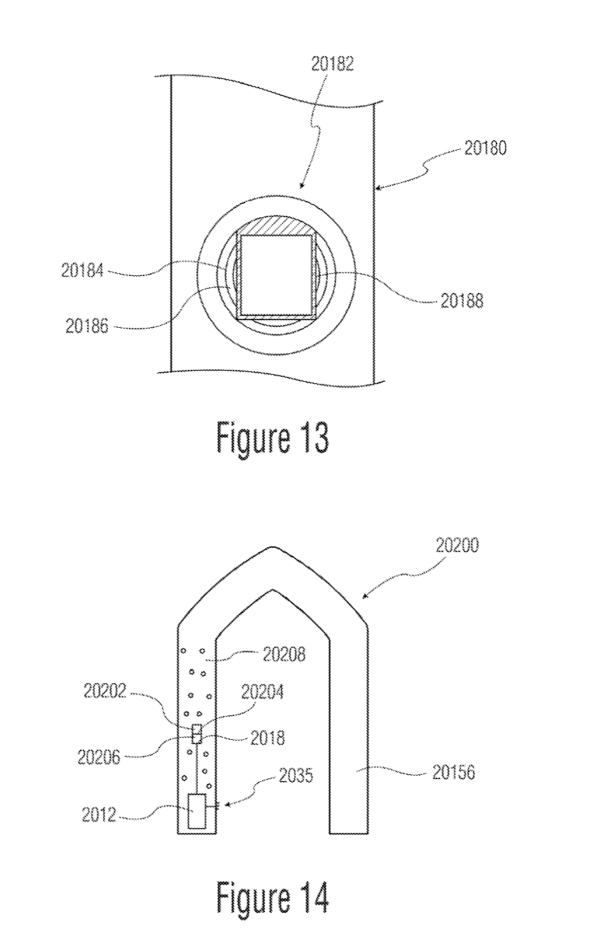

FIG. 13 shows a portion of an alternative inflatable bladder 20180 for use in an embodiment safety apparatus. The bladder 20180 includes a sealable closure 20182 whereby access can be gained to the interior of the bladder 20180. The sealable closure 20182 will typically be welded in position to the bladder 20180. The sealable closure 20182 comprises a press-seal (clip-lock), rather than a pressure zip fastener as employed in the above described embodiment. The press-seal closure 20182 comprises male and female engagement portions 20184 and 20186 which sealingly engage when pressed together. To locate the sealable closure 20182 in an open condition a pull-tab 20188 is provided whereby the male and female engagement portions 20184 and 20186 are peeled apart. In order to re-seal the press-seal closure 20182 the male and female portions 20184 and 20186 are simply pressed together so as to be sealingly engaged. The press-seal sealable closure 20182 is produced from nylon. It will, however, be understood that the press-seal could be produced from other materials.

In a non-illustrated embodiment, the pull-tab 20188 is replaced with an oral inflator tube. When access to the interior of the bladder is required a user can simply apply a pulling force to the oral inflator tube.

In a non-illustrated embodiment, the safety device includes a cooling agent to dissipate heat generated during the chemical reaction which produces inflating product. In a preferred embodiment the cooling agent is a cooling gel sold under the trade name COOL GEL™ by LA-CO Industries, Inc., Illinois USA. In one non-illustrated embodiment, the cooling agent is admixed with material acting during the chemical reaction producing inflating product.

FIG. 14 shows a third embodiment safety apparatus 20200 comprising a container 20202 located inside an inflatable bladder 20156. The container 20202 holds a first substance 20204 to be employed in producing inflating product. The container 20202 further holds an amount of a pyrotechnic composition 20206 which is in use ignited by an igniter 2018. The igniter 2018 and pyrotechnic composition 20206 constitute the actuator of the safety apparatus 20200.

The inflatable bladder 20206 holds a second substance 20208. In use the controller 2012 will cause the igniter 2018 to ignite the pyrotechnic composition 20206 responsive to measurements taken by the sensor assembly 2035. Ignition of the pyrotechnic composition will cause rapid combustion which will rupture the container 20202 and allow the first and second substances to come into contact to allow a chemical reaction to take place during which inflating product is produced.

In one example, the first substance is hydrogen peroxide (2H₂O₂) and the second substance is potassium permanganate (KMnO₄).

In a non-illustrated embodiment, the safety device includes a shark repelling device adapted to generate a sound signal to repel sharks when the safety device is used at sea.

In a further non-illustrated embodiment, the safety device includes a satellite SIM unit.

In another non-illustrated embodiment of the safety device the information display module comprises a waterproof touchscreen.

In a non-illustrated embodiment, the container includes a fill valve so that the container can be filled with reactants conveyed under pressure into the container.

In the specification, rupture includes, within its meaning: to pierce, break, break open, cleave, destroy completely, break open, burst, crack, fracture, open, puncture, shatter, split or tear.

In a preferred form, the electronics of the present invention can include CPU functions, resetting, testing, activating; batteries ×2 in module and ×1 in manual electro cord; pressure switch; activation system (DUO activation canister) (DUO); re-arming system (electronics); sim card option (satellite); test system function (a full system check); fault recording data (insurance purposes); motion sensor on/off/circuit test; battery test; circuit test; activation system test; GPS system locator; low battery alarm; heart monitor circuit; warning alarm; recharging circuit; remote activation circuit; electronic/manual pull cord system/circuit; Infra Red Depth sensor system; service Alarm circuit; battery recharging systems 12v, 240v, 110v USB, Cradle, Proximity Charge, Nano Charge; combination water/pressure sensing switches; pressure switch circuit to reset pressure switches to zero; circuit to reset servo motor (re-arm); personal data circuit to record ownership etc of EBBS (insurance purposes and government knowing that a person owns the PFD, Worldwide Data Base); new electronic circuit (cultured, grown)(the entire EBBS electronics produced this way); pressure switches have a latex skin covering the mechanism which reduces the chances of getting wet and also allows the system to still function correctly; pressure switches oil filled to reduce any moisture getting in and allows the system to still function correctly.

In the embodiment of a swim shirt, the procedures include entering the water: Pick up shirt—this activates the motion sensor which turns system ON and then undertakes a full system check including: 1/ circuit check 2/ battery check 3/ activation system check 4/ pressure switch resetting to zero pressure mode. The shirt is now ready to wear and operate. if any function indicates a warning then the user must not use the device.

If everything is ok to use and a user is wearing the Swim Shirt, a user can now enter a body of water and once the water pressure sensors sense a depth of the water (e.g. 100 mm) the CPU switches the unit into sense mode and awaits the pressure switch to sense the real desired depth (e.g. 1 metre). Once the user has reached the desired depth of activation, a signal has now been sent to the CPU digital timer which now starts counting up, if the timer goes past the required time there is now a signal sent from the CPU to the activation system to activate and inflate the bladder. If this has happened, there is now an app sent to a nominated phone (via the sim card satellite mode) which alerts a person that the wearer is in trouble. There is also a signal sent to the authorities alerting them of a person in trouble which also the GPS locator sends a signal of where the person is situated.

If a user is in the water and a user goes down under the desired level of water and then resurfaces, the timer resets back to zero waiting for the next command of countdown. This can continue until activation is required.

When a user takes his or her shirt off for a period of time (e.g., 30 minutes) the motion sensor will shut down and turn off the CPU until next use, if a user were to then travel to a different location e.g., up a mountain and the ambient air pressure is different, upon picking up a user's shirt again, it will go through all the desired checks and then reset the pressure switches to zero and is ready to use at the different location.

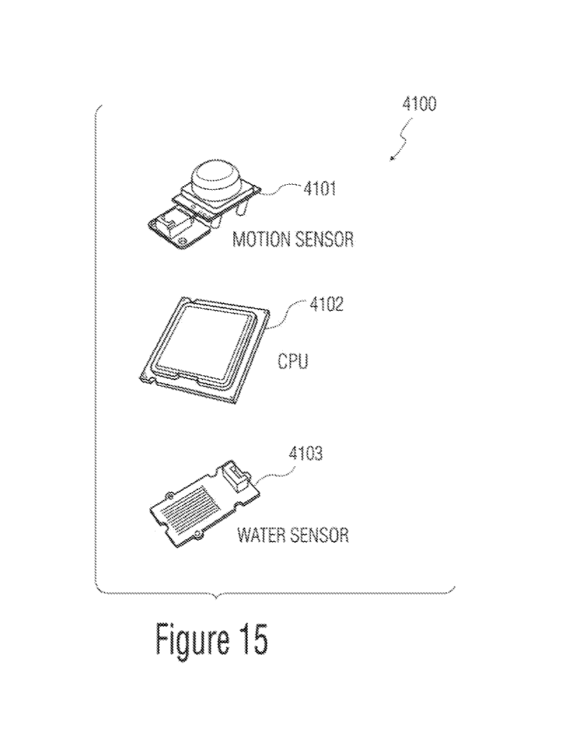

FIGS. 15 to 21 show the control module logic flow charts for use with embodiments of the present invention. FIG. 15 shows a toddler safety device where the system is not activated. The wearer picks up a module (generally 4100) and the motion sensor 4101 activates the test circuit, batteries 4111 and resets it to zero. The activation system is also tested and rearmed (if required). Once the system has been left idle for a set period (eg. 1 hour) it will turn itself off and will do the same function as soon as it has been picked up again. The CPU 4102 activates the first water sensing switches (circuit) 4103 ready to accept the sensing of water/moisture if it appears. If no water has been detected by these posts, they will remain open circuited and this is where the system remains. All LEDs 4110 will flash green when all is OK and red when there is a failure warning.

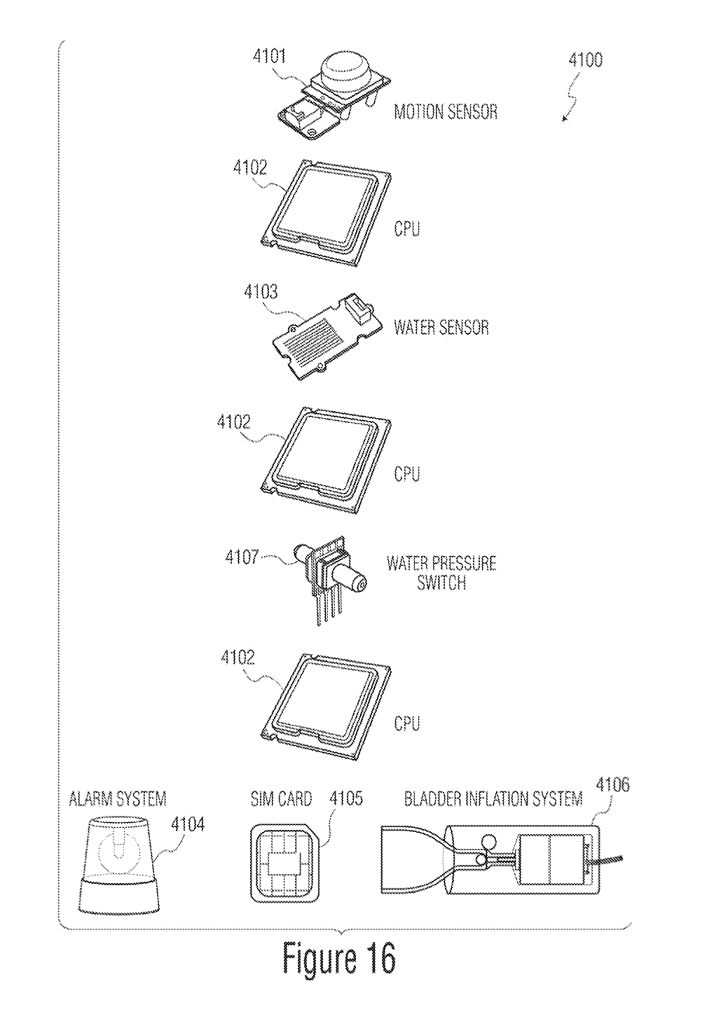

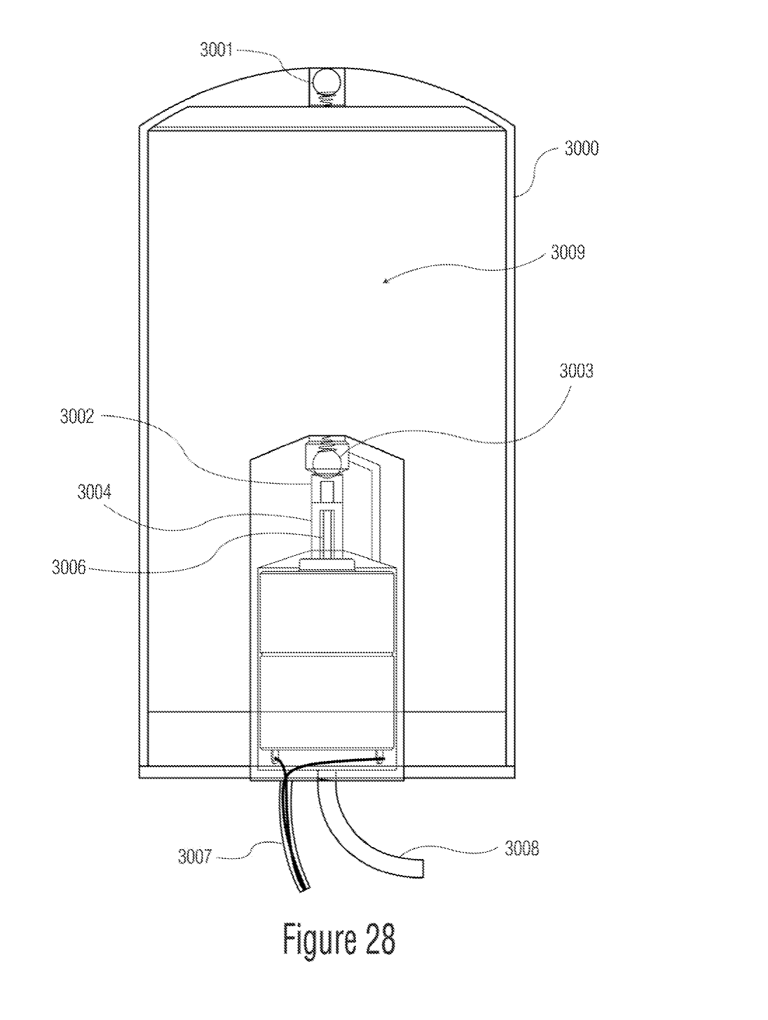

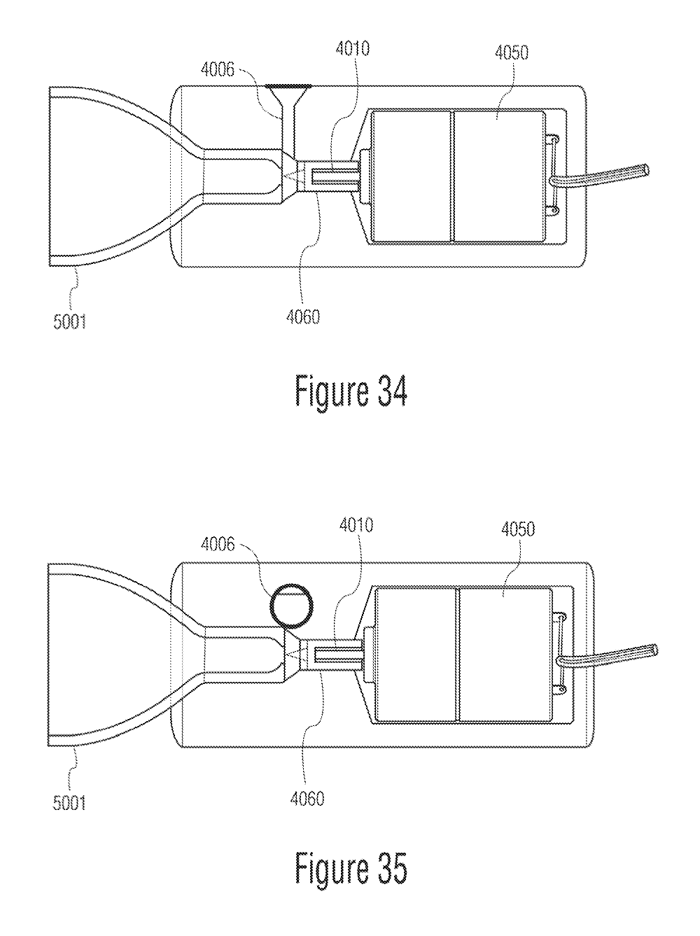

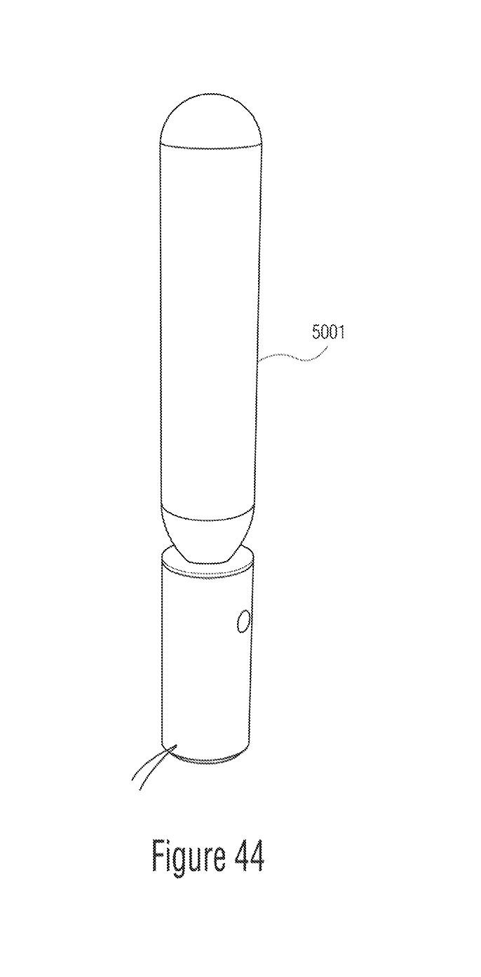

FIG. 16 shows the toddler safety device of FIG. 15 where the system is activated. The wearer picks up the module and the motion sensor activates (arms) and tests the circuits, batteries and resets switches to zero. The activation system is also tested and rearmed (if required). Once the system has been left idle for a set period (eg. 1 hour) it will turn itself off and will do the same functions as soon as it has been picked up again as previously described above. The CPU now activates the first water sensing switches (circuit) ready to accept the sensing of water/moisture if it appears. If no water has been detected by the opposing circuit posts (not shown), they will remain open circuited and this is where the system remains. If water is detected, they now send a closed circuit signal back to the CPU. The CPU now sends a signal to the water sensing pressure switches 4107 putting them into standby mode to detect the body of water and not just rain, hosing, waves or perspiration. If these two water sensing switches are activated by being within a body of water, they will send a signal back to the CPU. The CPU now sends a signal to the Duo activation system to activate and release the CO₂ by way of the bladder inflation system 4006 (see FIGS. 28 to 45). The CPU will also rearm the activation system so that the user can replace the CO₂ canister, ready for reuse. The CPU will then activate the alarm 4104 and a signal will be sent using the sim card 4105, to a designated mobile phone to appear as an app notification alerting the parent that their child is in danger, and also provide a GPS pinpointing the child's exact location.

In the new Actuator Canister Combination (Duo), there is a reduction in size of the actuator and combination within the canister or you can have them separate. By using a micro DC motor and Gearbox combination you can now either pierce a current CO2 bottle or depress the new CO2 Canister or new adaptor to fit onto an existing CO2 bottle. This is a new method of breaking, piercing or opening a valve. The system works in the following manner: in the #1 Stand alone RETRO DUO. There is the separate electronic CPU module which controls the actuator. Once the CPU sends a signal to the DUO, the internal servo motor/Gearbox rotates and turns the threaded actuator pin, by turning this pin clockwise it advances upwards and pierces the CO₂ bottle. As soon as this function has been achieved and the gas has entered the bladder, the CPU now engages into reset mode which now reverses the servo motor/gearbox and rotates the pin anti clockwise and the pin now retracts away from the CO2 bottle and is now set in rearm position. A user can now remove the spent CO₂ canister and refit a new canister and the system has rearmed itself and is now ready to operate again. The bottle is the only item you replace. No more replacing the dissolving tablet or firing module.

In the second version #2, Stand alone RETRO DUO used is a ball valve adaptor on an existing CO₂ Bottle. There is the separate electronic CPU module which controls the actuator. Once the CPU sends a signal to the DUO, the internal servo motor/Gearbox rotates and turns the threaded actuator cupped pin, by turning this threaded pin clockwise it advances upwards and depresses the ball valve adaptor attached to a current CO2 bottle. As soon as this function has been achieved and the gas has entered the bladder, the CPU now engages into reset mode which now reverses the servo motor/gearbox and rotates the cupped pin anti clockwise and the cupped pin now retracts away from the CO₂ bottle and is now set in rearm position. You now remove the spent CO2 canister and refit a new canister and the system has rearmed itself and is now ready to operate again. The bottle with the new ball valve adaptor is the only item you replace. No more replacing the dissolving tablet or firing module. This bottle system can be refilled so that there is no need to throw away).

Lastly in the third variation #3 Stand alone RETRO DUO Actuator Canister, there is the separate electronic CPU module which controls the actuator. Once the CPU sends a signal to the DUO, the internal servo motor/Gearbox rotates and turns the threaded actuator cupped pin, by turning this pin clockwise it advances upwards and depresses the ball valve inside the Actuator Canister. As soon as this function has been achieved and the gas has escaped the Actuator Canister, the CPU resets the internal servo motor/Gearbox within the canister. You now remove the spent DUO Actuator Canister and refit a new DUO Actuator Canister and the system is now ready to operate again. The DUO Actuator Canister is the only item you replace. No more replacing the dissolving tablet or firing module. Swap and Go with the canister at any service center. The service center refills the spent canister ready to function again.

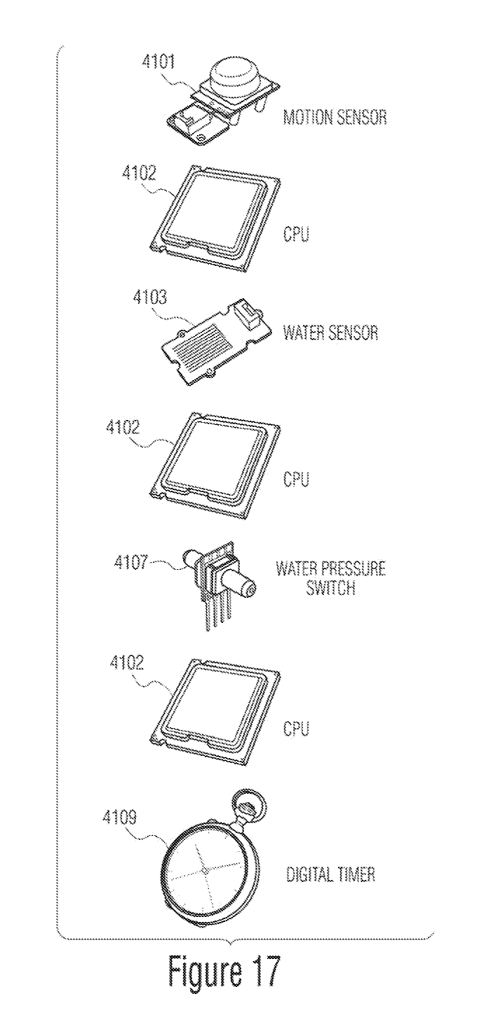

In FIG. 17, a new Duo personal safety device is shown in swim mode and not being activated. In this embodiment, the wearer picks up the module and the motion sensor activates and tests the circuit, batteries and reset switches to zero. The activation system is also tested and rearmed (if required) Once the system has been left idle for a set period (eg. 1 hour) it will turn itself off and will do the same functions as soon as it has been picked up again. The wearer now enters a body of water to swim, the CPU now activates the first water sensing switches which in turn also activate a closed circuit signal back to the CPU, the CPU now activates the two time sensing water pressure switches which will also close circuit switching and send a signal back to the CPU. The CPU will now activate the main water pressure switch which will now sit idle until the desired depth has been achieved. It will then send a signal back to the CPU, which in turn will then send a signal activating the digital timer 4109 which commences counting. Once the wearer rises above the threshold depth, the pressure switch signals the CPU and the timer resets to zero. The CPU will then switch back to the main water pressure switch. The system keeps stopping the CPU from activation as the wearer keeps rising above the required activation point threshold. This is either by staying above the activation depth or activation time. This system keeps functioning continuously in this manner if activation points are not reached.

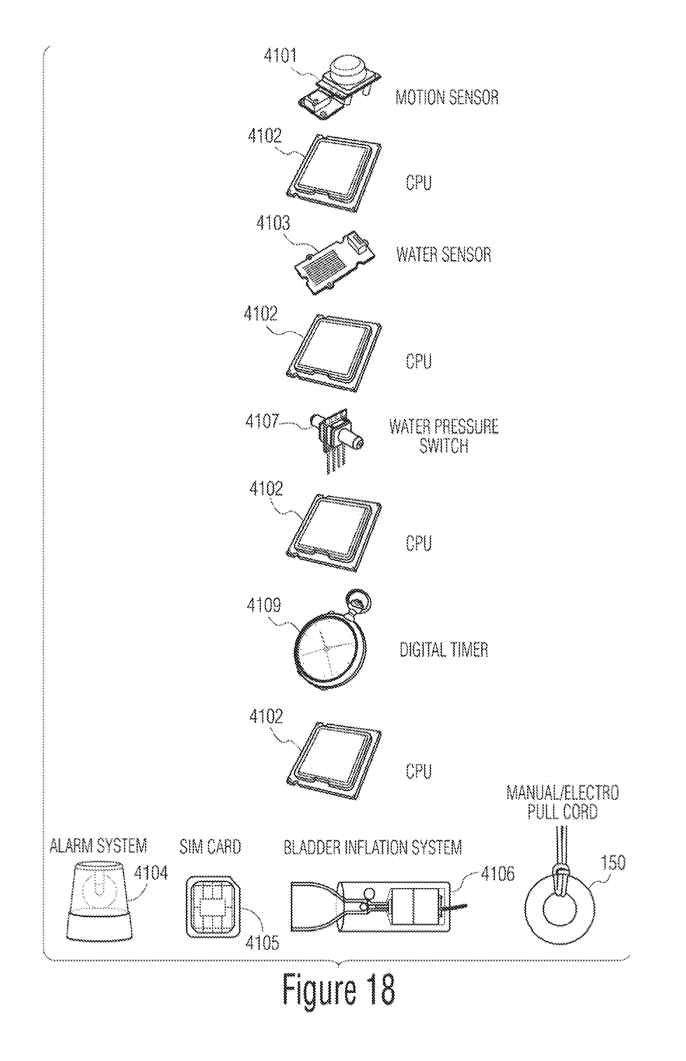

In FIG. 18, the new Duo personal safety device of FIG. 17 is shown in swim mode and where the system is activated. The wearer picks up the module and the motion sensor activates and tests the circuit, batteries and resets switches to zero. The activation system is also tested and rearmed (if required). Once the system has been left idle for a set period (eg. 1 hour) it will turn itself off and will do the same functions as soon as it has been picked up again. The wearer now enters a body of water to swim, the CPU now activates the first water sensing switches will in turn also activates a closed circuit signal back to the CPU. The CPU now activates the two time sensing water pressure switches which will also close circuit the switching and a send a signal back to the CPU. The CPU will now activate the main water pressure switch which will now sit idle until the desired depth has been achieved. It will then send a signal back to the CPU, which in turn will then send a signal activating the digital timer which commences counting. Once the wearer rises above the threshold depth, the pressure switch signals the CPU and the timer resets to zero. The CPU will then switch back to the main water pressure switch. If the wearer stays below the threshold depth for a set period of time (eg., 15 seconds), the digital timer sends a signal back to the CPU to activate and initiate the inflating of the bladder. The CPU now sends a signal to the Duo activation system to activate and release the CO₂. The CPU will also rearm the activation system so that the user can replace the CO₂ canister, ready for reuse. The CPU will then activate the alarm and a signal will be sent using the sim card, to a designated mobile phone, which will appear as an app notification. The sim card will also notify the authorities and provide GPS coordinates of the wearer. This could include night time alerting, LEDs flash in emergencies and the LEDs could also warn and advise that the system has been activated.

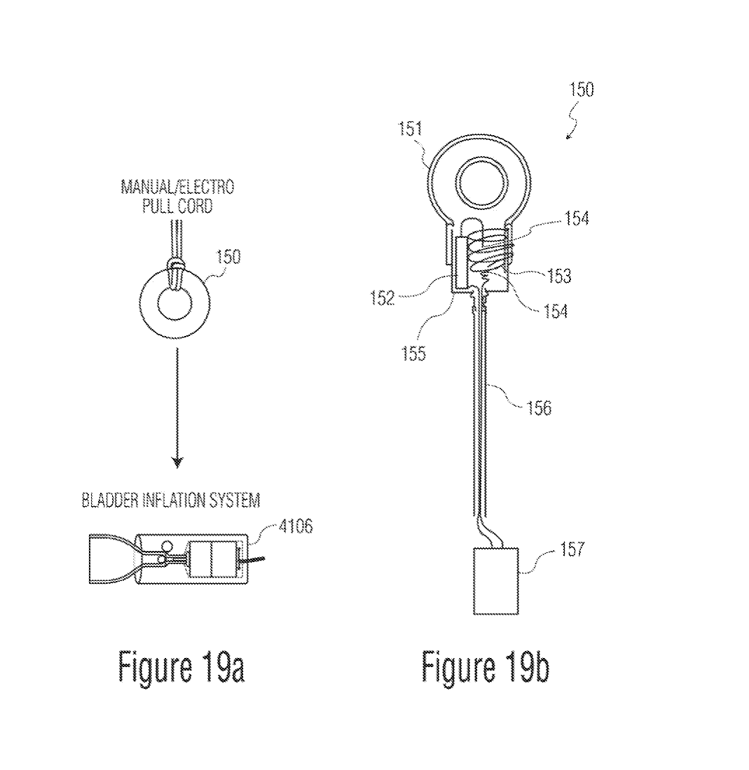

In FIGS. 19a and b, the Duo swim mode embodiment of the present invention is shown activated manually. In this embodiment, it shows the system has been activated by the manual/electrode pull cord independent of the main system for the purpose of being another form of activation should the main CPU and battery system fail. The manual electro pull cord 150 consists of a pull handle 151, battery 152, tension spring 153, a set of contacts 154, a water proof handle 155, water proof conduit 156 connecting it to the activation module 157. The handle 155 consists of a system where it slides inside the track of the water proof handle and the spring separates the contacts until the exertion of pulling on the handle will bring the contacts together to short out the activation system. The spring is of the same tension as a current manual handle in the sense that a user will not be able to accidently activate the manual operation. The battery is also used as a means of running the electronics as a backup. The manual/electro battery is recharged in conjunction with the main and backup batteries and works separately when required. By pulling the cord, a circuit is closed allowing the battery to activate the activation module. The spring is used to tension the handle (ring).

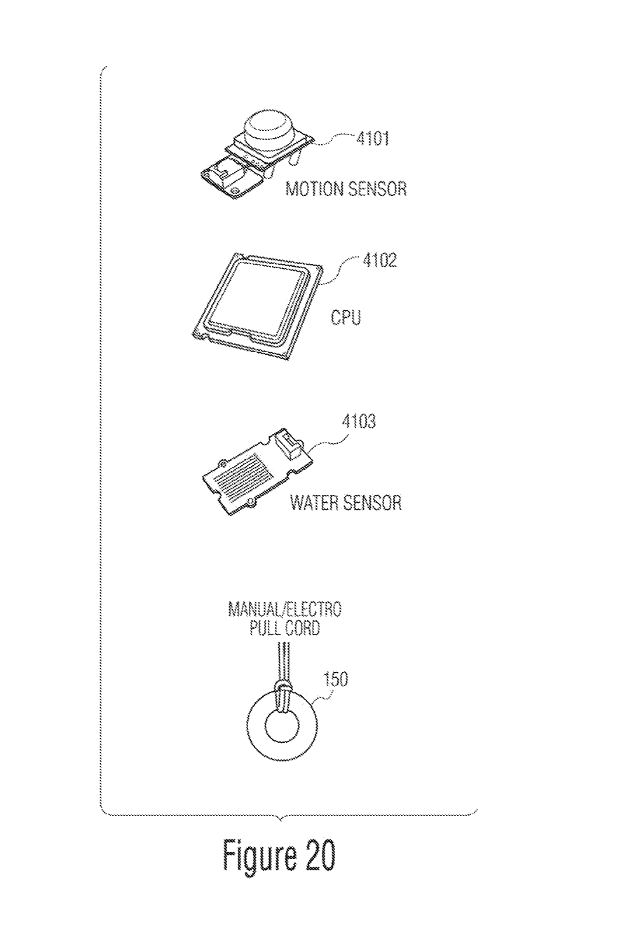

In FIG. 20, the Duo safety device of an embodiment of the present invention is shown in instant mode, and where no activation occurs. In this embodiment, the wearer picks up the module and the motion sensor activates and tests the circuit, batteries and resets switches to zero. The activation system is automatically tested and rearmed (if required). Once the system has been left idle for a set period (eg. 1 hour) it will turn itself off and will do the same functions as soon as it has been picked up again. That is, testing and rearming itself. This includes the CPU activating the first water sensing switches (circuit) ready to accept the sensing of water/moisture. It also includes testing the circuits, batteries, firing system, pressure switches and resets. If no water has been detected, the posts on each side of the circuit will remain open circuited and this is where the system remains until another event occurs such as the presence of water or a further self-test.

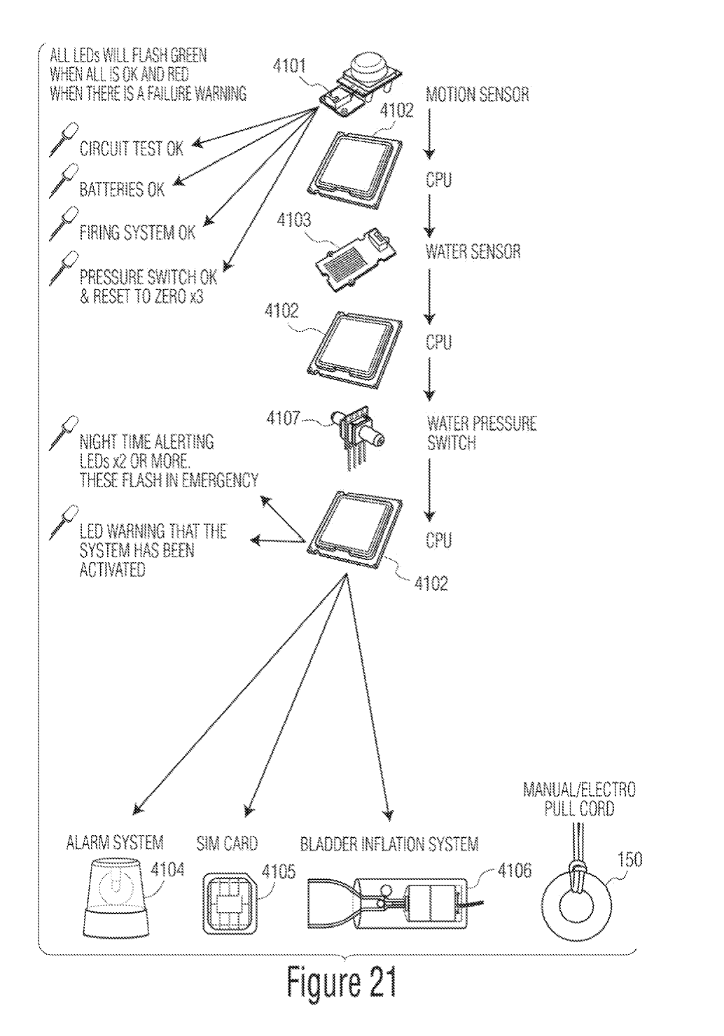

FIG. 21 shows an instant mode of the Duo PFD and safety activation. In this embodiment, the wearer picks up the module and the motion sensor activates and tests the circuit, batteries and resets switches to zero. The activation system is also tested and rearmed (if required). Once the system has been left idle for a set period (eg. 1 hour) it will turn itself off and will do the same functions as soon as it has been picked up again. The CPU now activates the first water sensing switches (circuit) ready to accept the sensing of water/moisture if it appears. If no water has been detected by these posts, they will remain open circuited and this is where the circuit remains. If water is detected they now send a closed circuit signal back to the CPU. The CPU now sends a signal to the water sensing pressure switches putting them into a standby mode to detect the body of water and not just rain, hosing, waves or perspiration. If these two sensing switches are activated by being within a body of water, they will send a signal back to the CPU. The CPU now sends a signal to the Duo activation system to activate and release the CO₂. The CPU will also rearm the activation system so that the user can replace the CO₂ canister ready for reuse. The CPU will then activate the alarm and a signal will be sent using the sim card, to a designated mobile phone, which will appear as an app notification. The sim card will also notify the authorities and provide the GPS coordinates of the wearer. This system will not activate by either rain, hosing, perspiration or by being hit by a wave. Activation will only occur by being submerged under a minimum depth of water (eg. 100 mm, 10 cm or 4 inches).

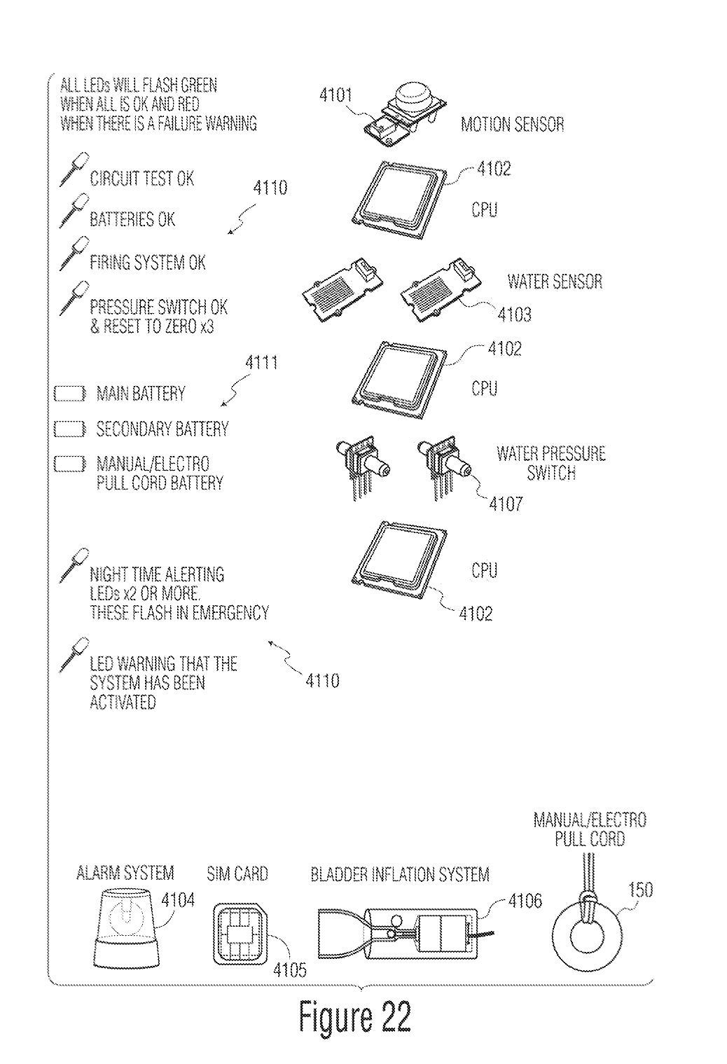

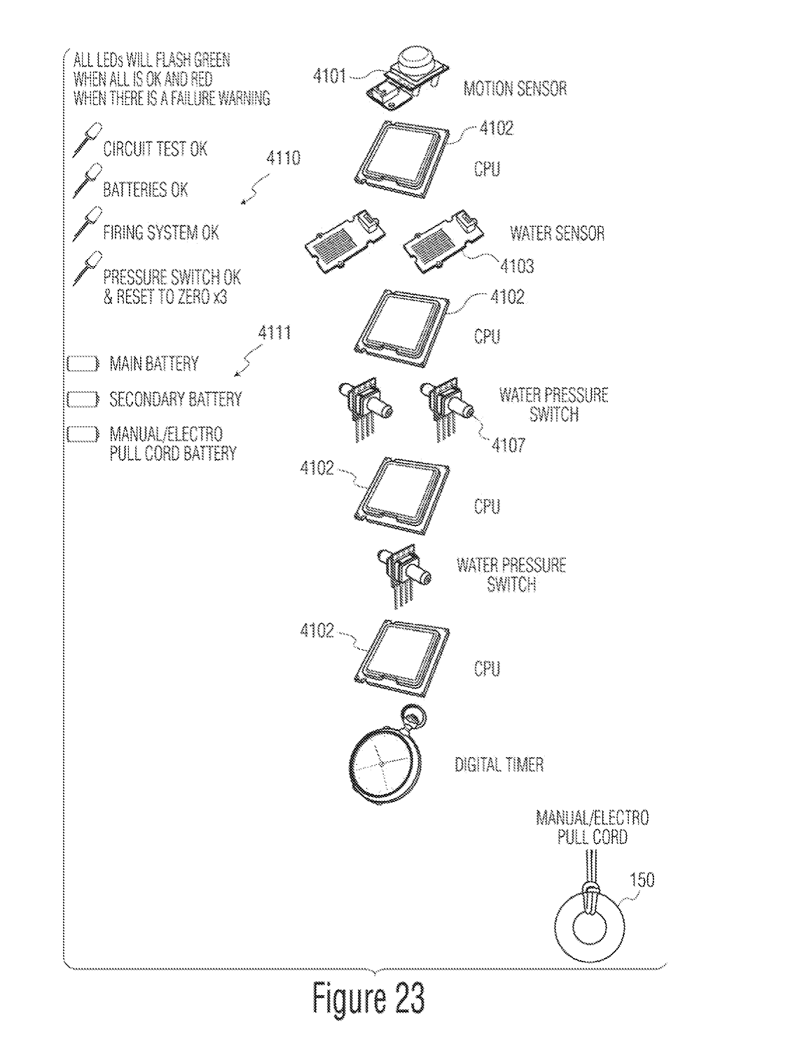

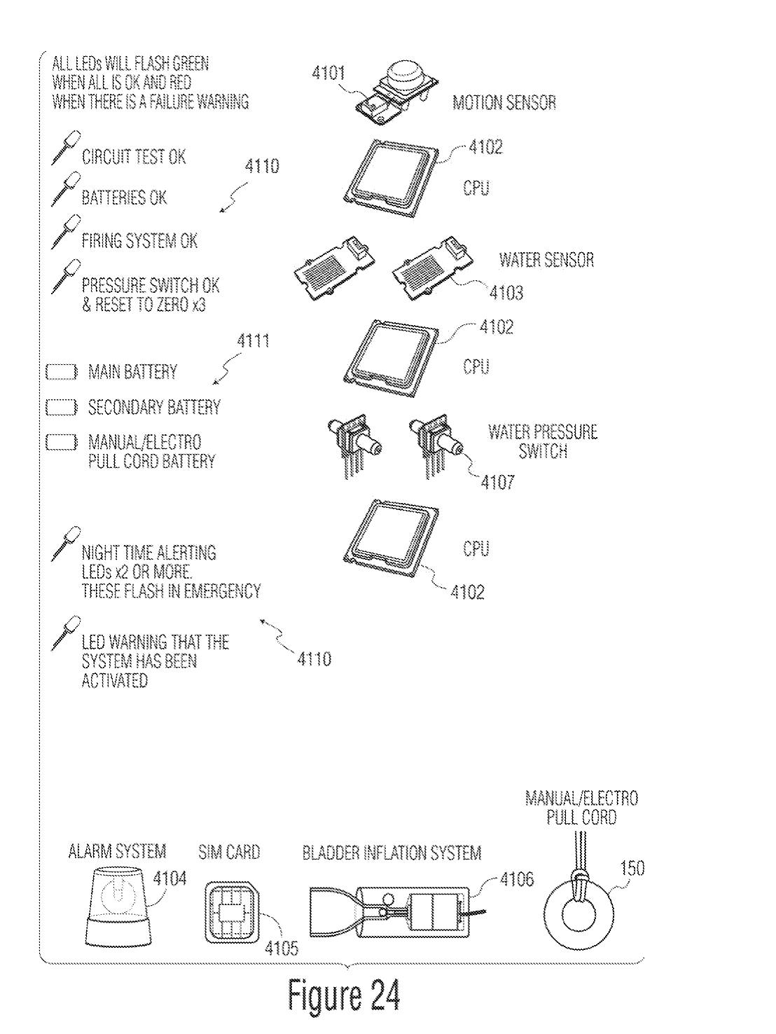

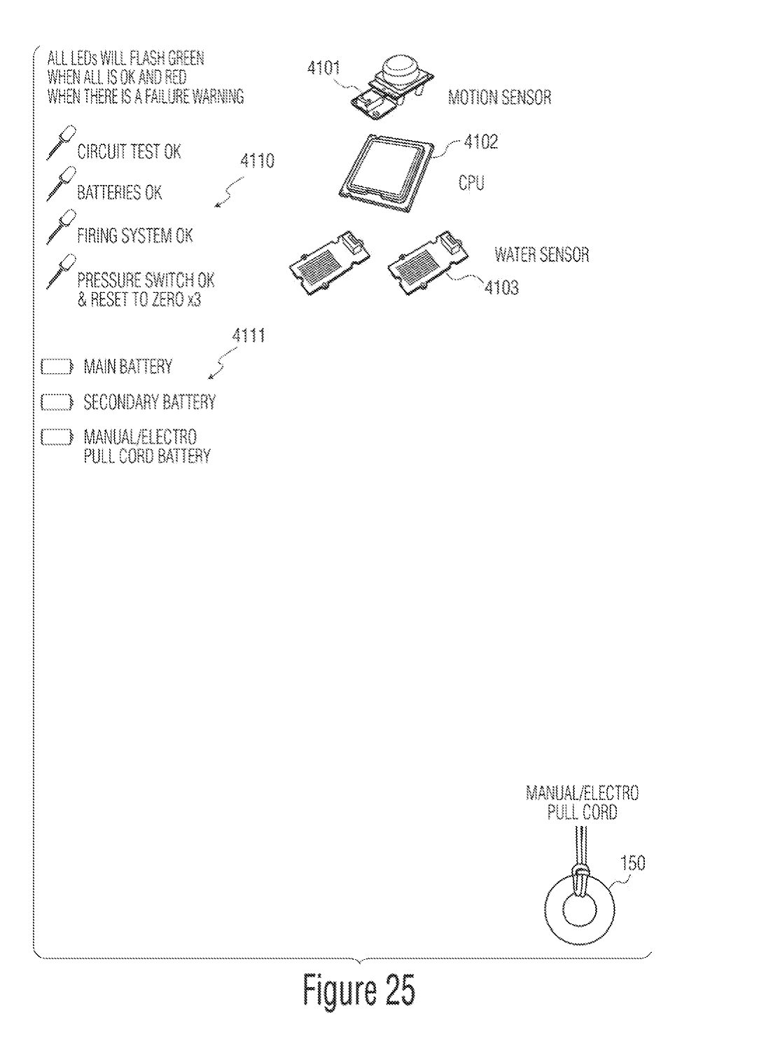

In FIGS. 22 to 27, the current Toddler shirt embodiment of the present invention can have the following: water switch posts can have a cap to stop accidental activation; CPU; battery; plastic module with water switch protection tracks; CO₂; water switch protection and cushioning pouch.

The module that the electronics are within has a system that will only let water in when a child is submerged. This is achieved by two means, firstly the position of the water inlet tubes which hold the water sensing switches in a manner that water can't enter from rain, hose perspiration etc. secondly the whole electronic board is placed into a pouch that will only let water into the pouch when a child is submerged. This pouch also acts as a cushioning system to make the system more comfortable to wear by the child.

In FIGS. 28 to 45, embodiments that can be retrofitted to existing inflatable devices are shown. Each show a DC motor having a micro gearbox to rotate a shaft. The shaft connected to a screw member 12 that moves along the shaft to push an end having a pin, cup or other protrusion to release gas from a gas canister.

FIG. 28 shows a new CO₂ and actuation canister for use with the present invention. In this embodiment, there is shown an outer casing 3001 having a depression or fuel valve to fill the cylinder with CO₂, a capped shaft 3002 to depress the ball valve 3003, the ball valve 3003 to release CO₂ out of the canister, a threaded rotating grub screw 3004, rotating shaft 3005, high pressure tubing 3006 to allow CO₂ to extend to the bladder and various wiring 3007. In 3009, CO₂ is present. For example, 33 grams of CO₂ can be used. The weight of the amount of CO₂ is dependent upon the size of the cylinder.

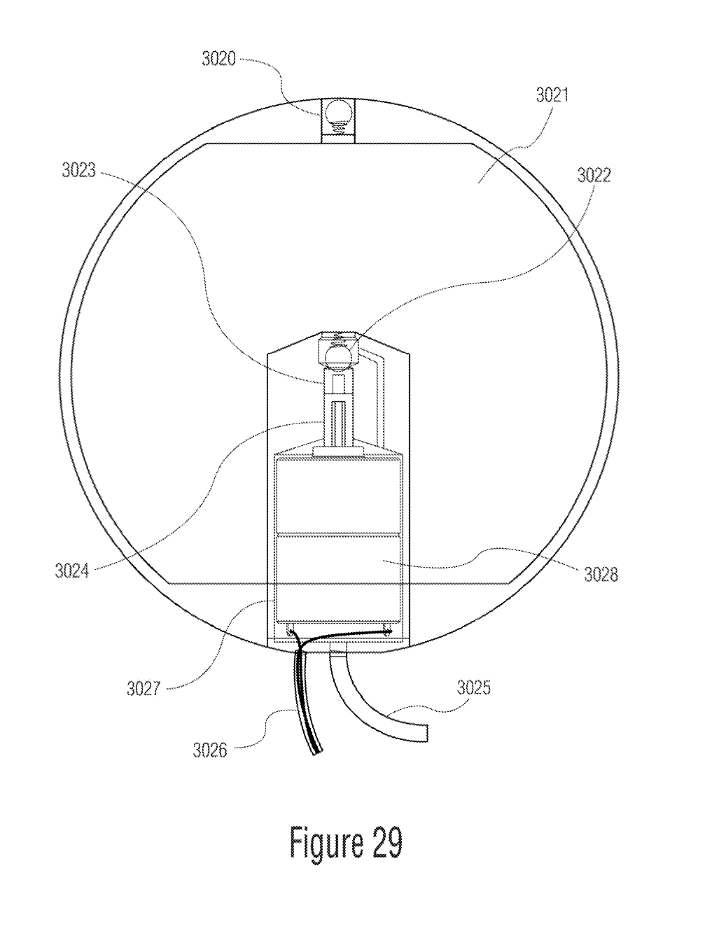

FIG. 29 shows an alternate embodiment of FIG. 28. In this form there is a depression ball fill valve 3020 to fill sphere chamber with CO₂/helium or the like. There is a space 3021 for the CO₂ and there is a ball valve 3022 to release CO₂ from the sphere. There is a rotating grub screw depression shaft 3023, a rotating hex shaft 3024, a high pressure hose fitting 3025 to allow CO₂ out through the conduit and high pressure hose fitting 3026 for internal wiring and then filled with glue and resin. There is also a DC motor 3027.

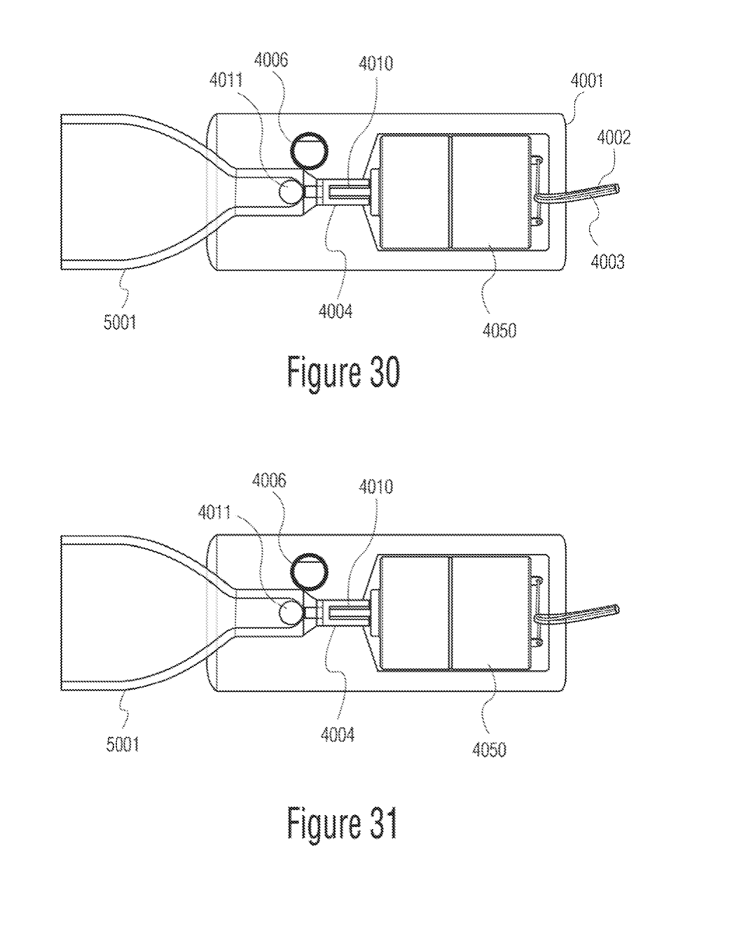

In FIG. 30, there is a shown a servo motor housing unit including a CO₂ bottle 5001. CO₂ flows from the bottle out into a bladder. There is a sealed end cap for motor installation 4001, wiring for the electronics 4002, high pressure air hose 4003, fitting for wiring 4002 and silicon filled to stop air loss. There is a grub screw 4004 which rotates from exertion of the motor and moves up the threaded shaft 4010 and depresses the ball valve 4011 to allow CO₂ to flow as shown.

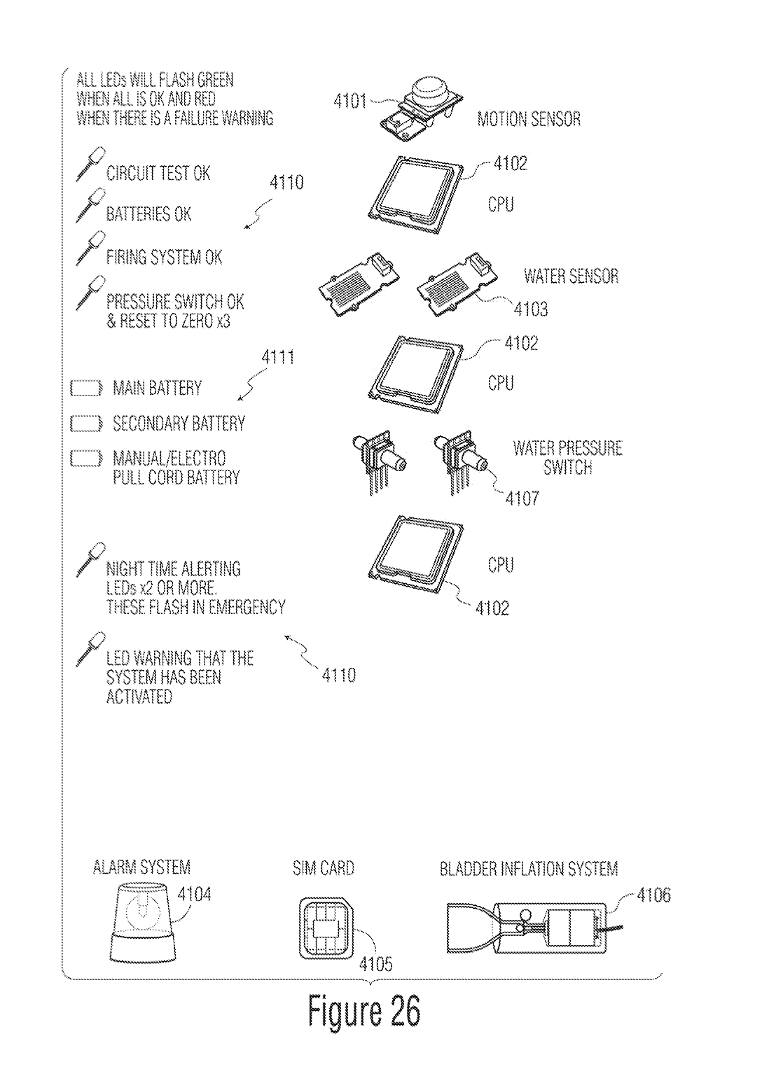

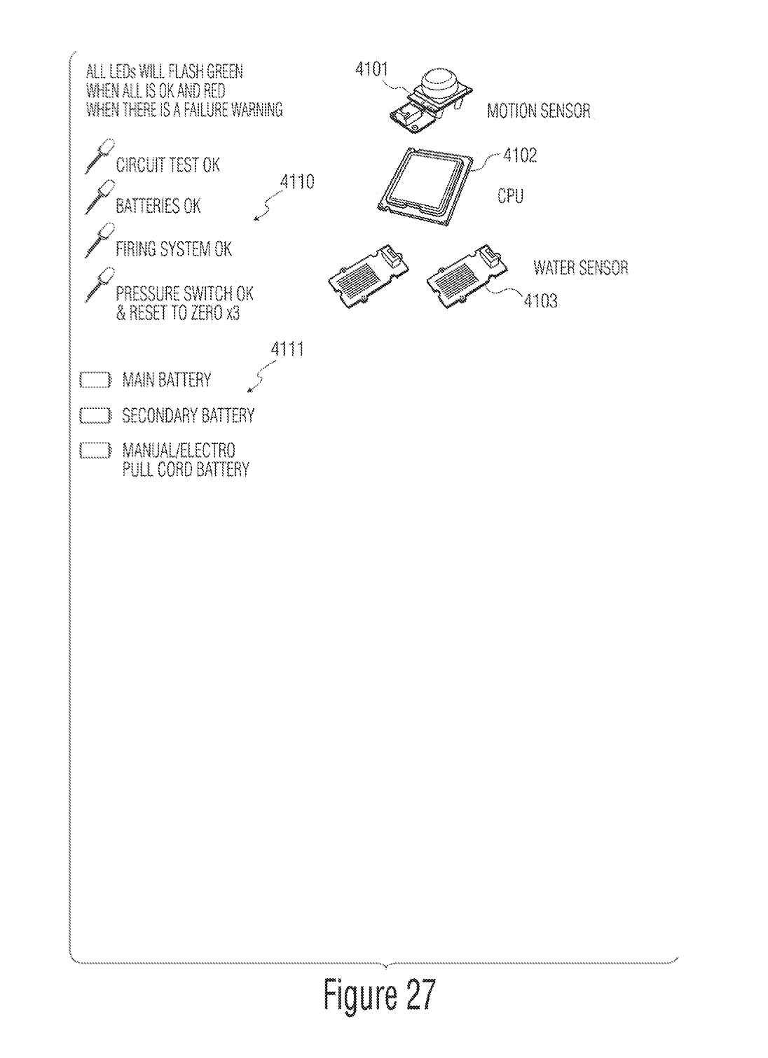

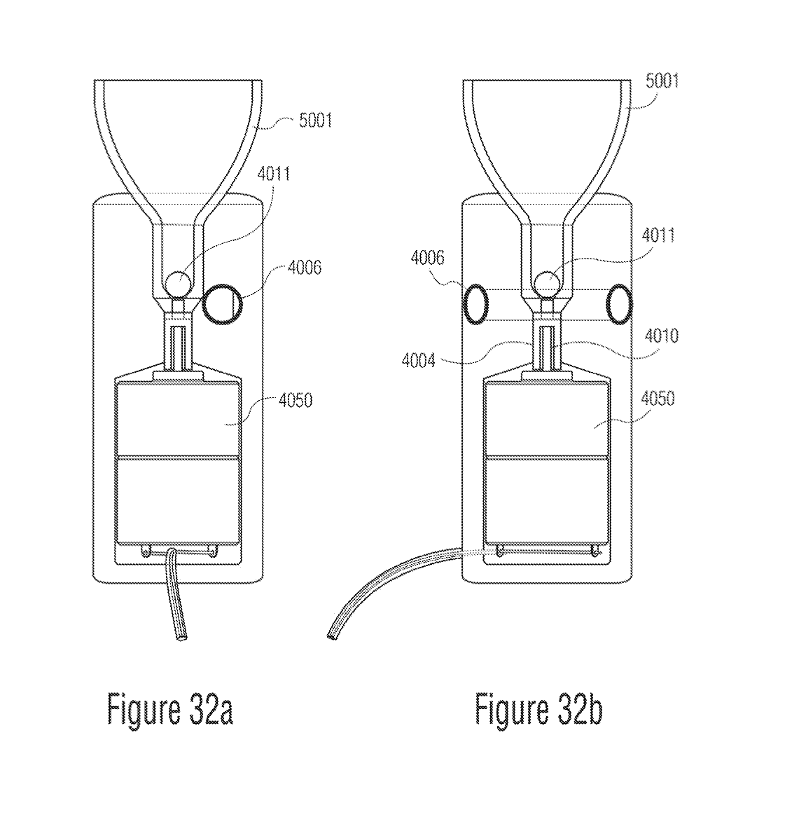

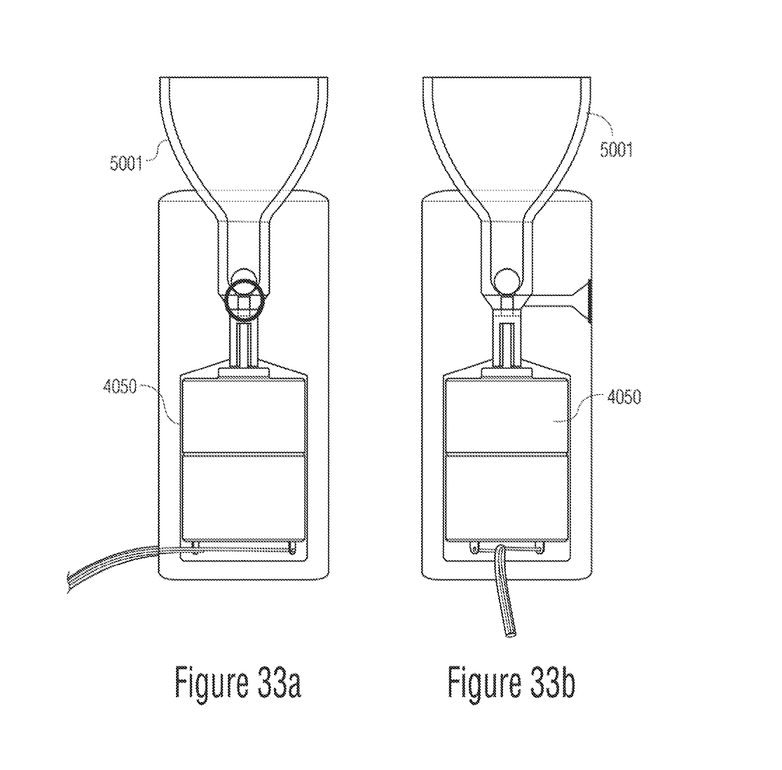

In FIG. 31, the servo motor of FIG. 30 is shown with the valve outlet 4006. In FIGS. 26 and 27 are shown the servo motor 4050 in various configurations as previously discussed. FIG. 32a is a front view of a servo motor housing unit and FIG. 32b is a side view of a servo motor housing unit. Likewise, FIG. 33a is a front view of another servo motor housing unit and FIG. 33b is a side view of another servo motor housing unit.

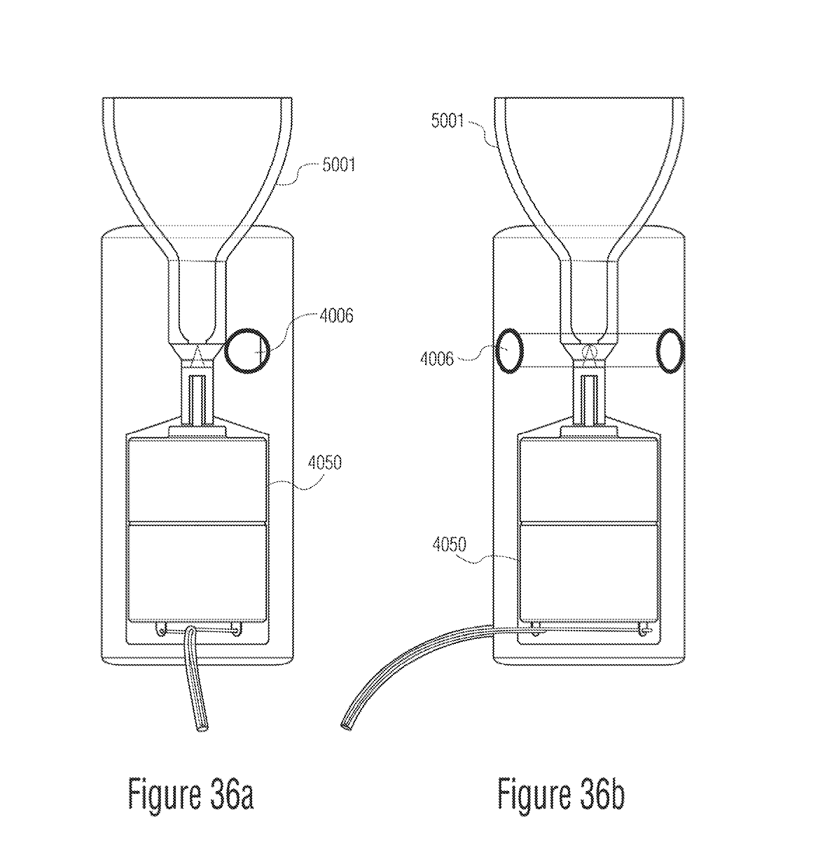

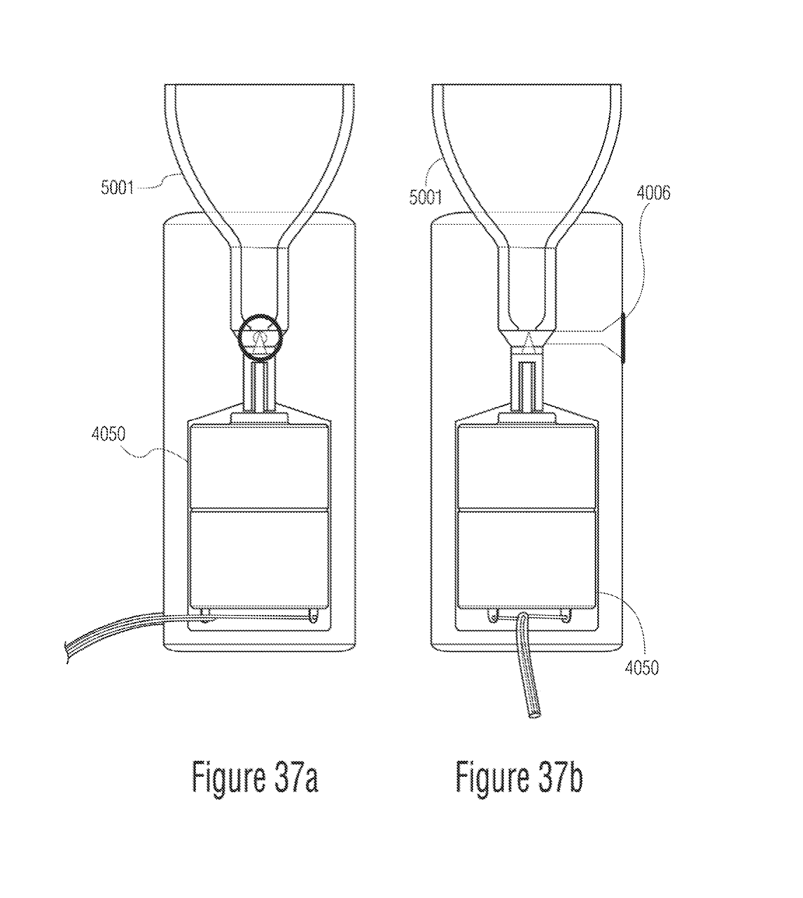

In the embodiments of FIGS. 35 to 37, a similar arrangement is shown however in this case a pin 4060 rotates from exertion of the motor and moves up the thread and pierces the bottle to allow CO₂ to flow. In this case the CO₂ flows from the bottle 5001 out through a Schrader valve 4062 and into a bladder through an oil tube glass fitting or directly into the bladder. FIG. 36a is a front view of a servo motor housing unit and FIG. 36b is a side view of a servo motor housing unit. Likewise, FIG. 37a is a front view of another servo motor housing unit and FIG. 37b is a side view of another servo motor housing unit.

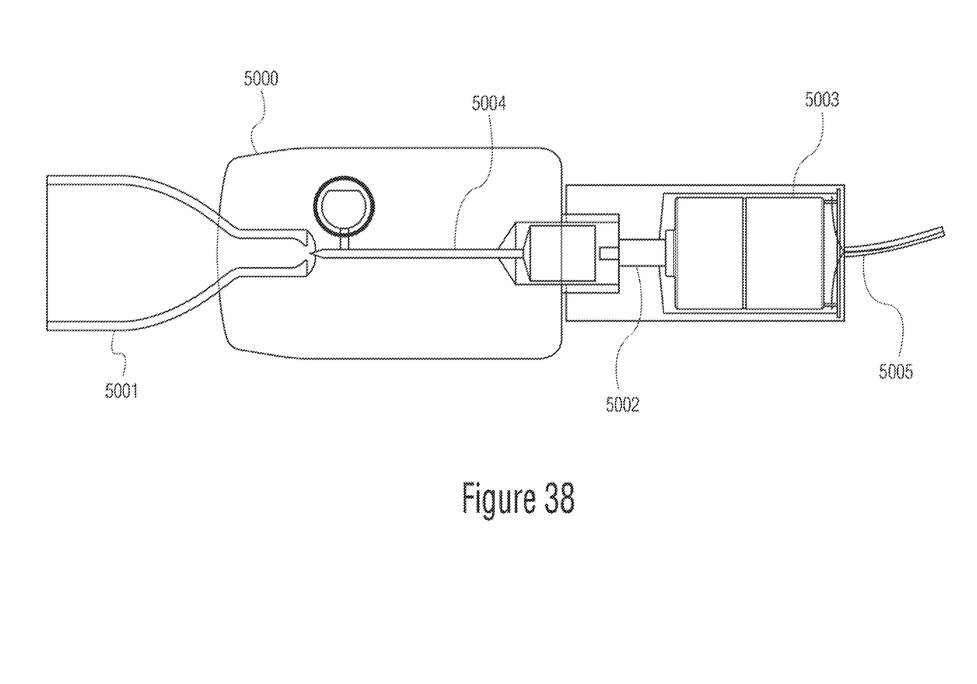

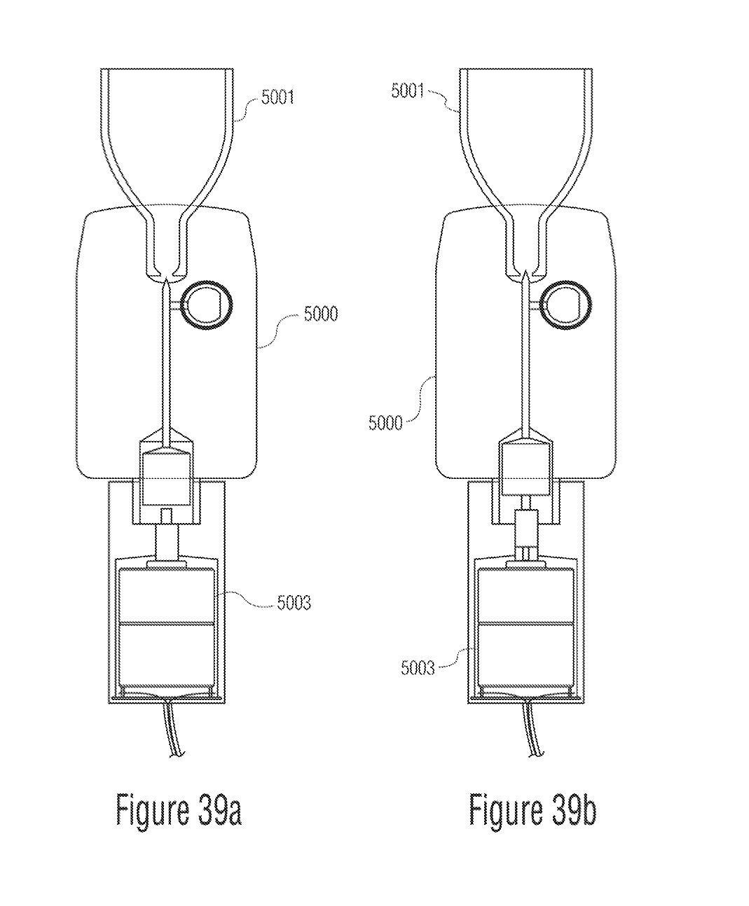

In FIGS. 38 and 39, there is shown a similar device but in this case the exertion pin retrofit. In this case there is a pre-existing unit 5000 with standard fittings being connected to a CO₂ bottle 5001. As there is a threaded section 5002 which slides up a D shaft when the servo motor 5003 rotates and it turns through the threaded section. As it turns it pushes the center pin 5004 through the bottle 5001 releasing the gas. In this case there could be a push-in/screw in high pressure hose 5005 used as a wiring protector and waterproofed to ensure that it will not let pressure out or water in.

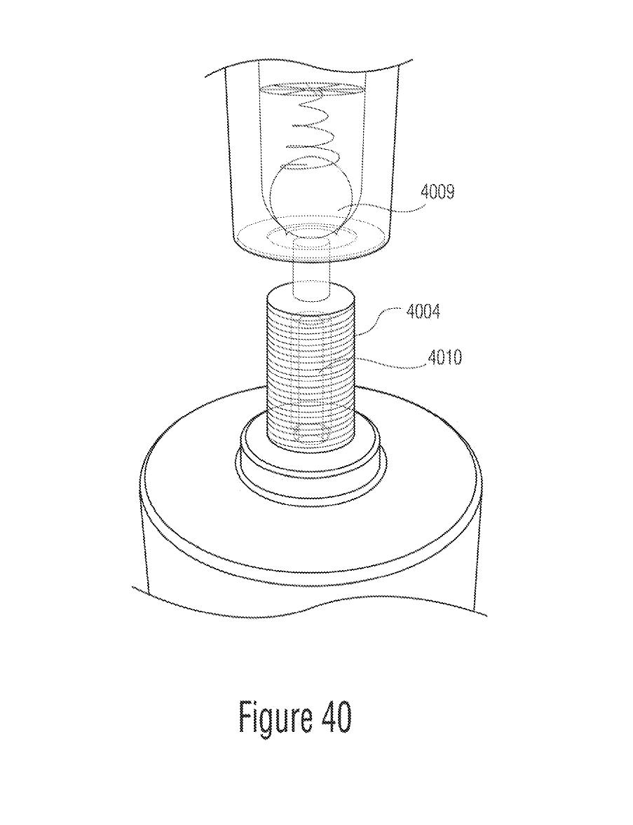

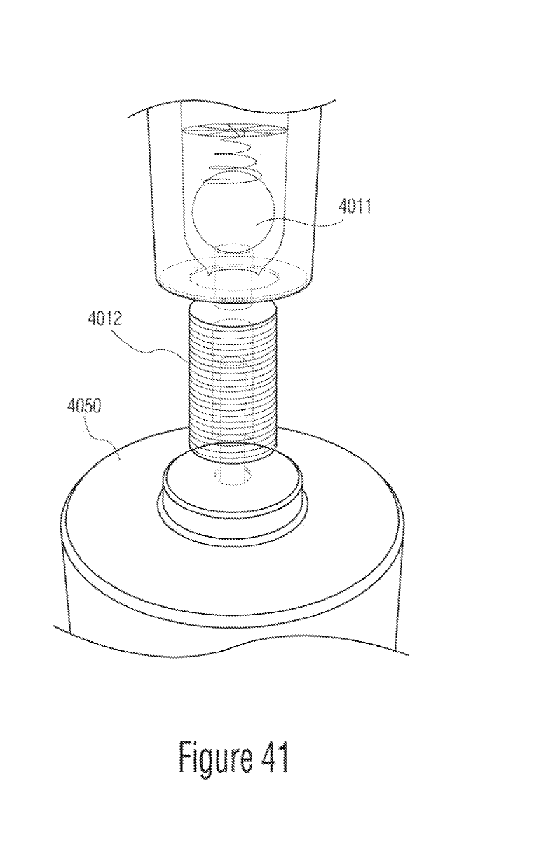

FIGS. 40 to 45 then show varies diagrammatic versions of the valves previously discussed. In FIG. 40, 4004 shows a grub screw position 1 and 4009 depicts a ball valve in a closed position. In FIG. 41, 4012 shows a grub screw position 2 and 4011 depicts a ball valve in an open position.

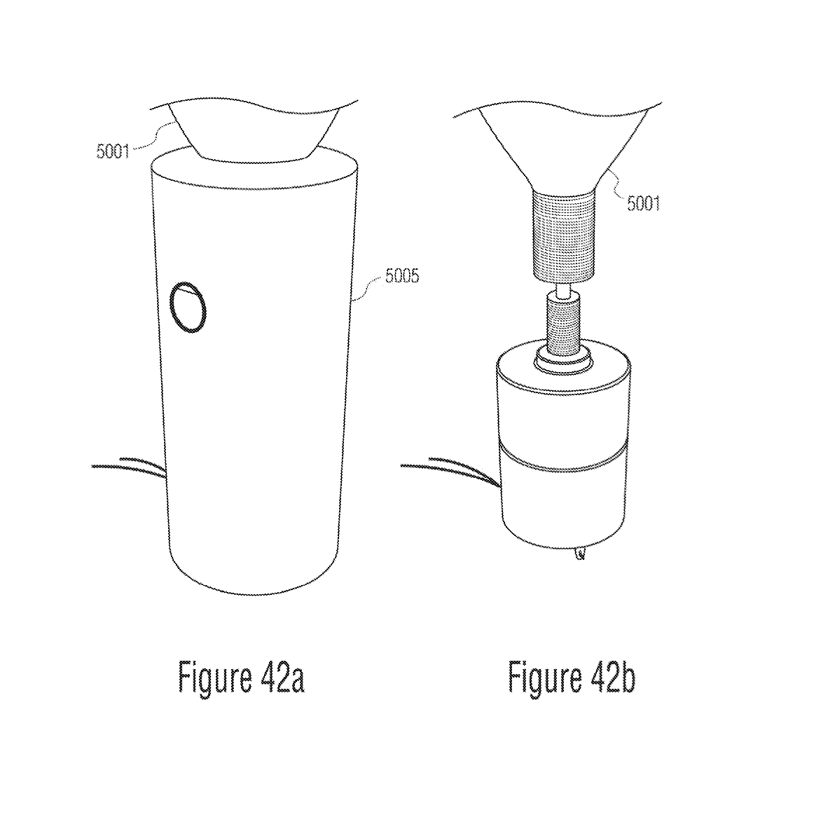

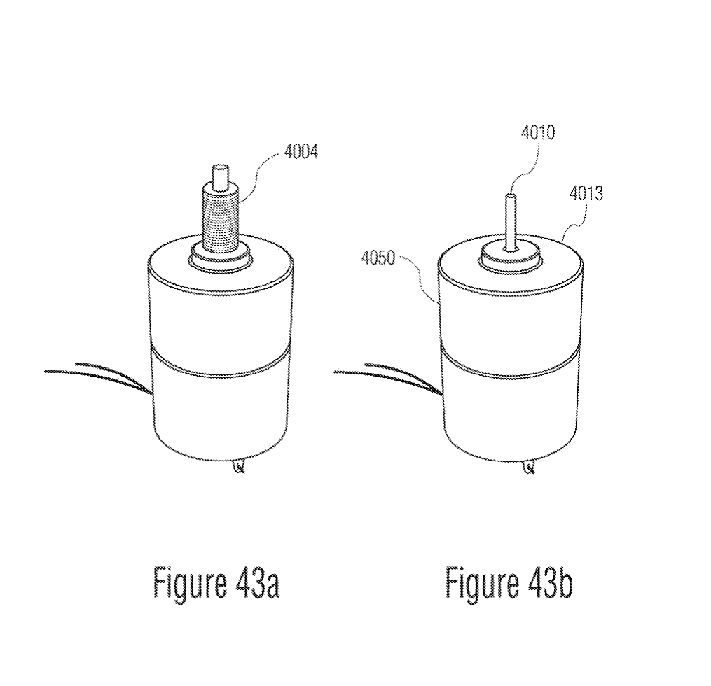

In FIG. 42a, 5005 depicts an outer casing and in FIG. 42b, 5001 includes a CO₂ bottle. In FIG. 43a, 4004 includes a threaded rotating grub screw. In FIG. 43b, 4010 includes a rotating shaft and 4013 shows a micro DC motor.

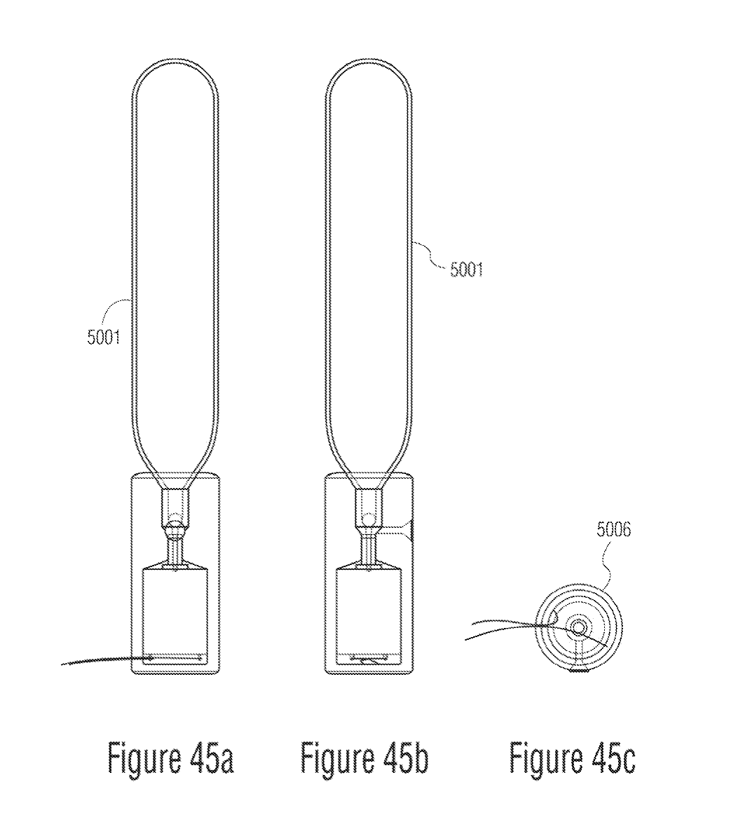

FIG. 45(a) shows a front view of a CO₂ bottle 5001 and FIG. 45b depicts a side view of a CO₂ bottle 5001. in FIG. 45c, 5006 depicts a top view of a CO₂ bottle 5001.

Advantageously, the present invention in various embodiments can provide a series of inflatable safety products. While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

1. An electronically controlled inflating apparatus for inflating an inflatable bladder with inflating product, the inflating apparatus comprising:
an actuator which upon activation is adapted to cause the inflatable bladder to be filled with inflating product;
a sensor assembly operatively associated with the actuator, the sensor assembly including a first pressure sensor assembly and a second pressure sensor assembly, the actuator adapted to cause inflation of the inflatable bladder responsive to measurements taken by the sensor assembly, and
a control module operatively associated with the sensor assembly, the control module including a switch to place the inflating apparatus in an instant activation mode of operation and a swim activation mode of operation respectively, whereby
(i) in the instant activation mode, the actuator is activated upon the first pressure sensor assembly detecting a first preset pressure; and
(ii) in the swim activation mode, the actuator is activated upon (a) the second pressure assembly detecting a second preset pressure; and (b) a preset time interval is measured by a timer of the control module after the second pressure sensor assembly has detected the second preset pressure.

2. An electronically controlled inflating apparatus according to claim 1 wherein the first pressure sensor assembly comprises a first and a second pressure sensor.

3. An electronically controlled inflating apparatus according to claim 2, wherein the first and the second pressure sensors are configured such that in the instant activation mode the actuator is only activated upon both the first and the second pressure sensors detecting the first preset pressure.

4. An electronically controlled inflating apparatus according to claim 3, wherein the first and second pressure sensors are first and second pressure switches.

5. An electronically controlled inflating apparatus according to claim 1, comprising a motion sensor to detect movement of the electronically controlled inflating apparatus.

6. An electronically controlled inflating apparatus according to claim 5, wherein the control module has a sleep state and an active state and wherein the motion sensor is operatively associated with the control module such that the control module is placed in the active state upon the detection of motion by the motion sensor.

7. An electronically controlled inflating apparatus according to claim 1, comprising a water sensing assembly operatively associated with the first pressure sensor assembly and configured to place the first pressure sensor assembly in a standby mode upon the detection of water by the water sensing assembly.

8. An electronically controlled inflating apparatus according to claim 7, wherein the water sensing assembly comprises a first and a second water sensing circuit and wherein the first pressure assembly is only placed in the standby mode upon both the first and second water sensing circuits detecting water.

9. An electronically controlled inflating apparatus according to claim 1, wherein the actuator comprises a servomotor.

10. An electronically controlled inflating apparatus according to claim 9, wherein the inflating product is stored in a cylinder operatively associated with the servomotor and whereby activation of the servomotor causes inflating product to be released from the cylinder to inflate the bladder.

11. An electronically controlled inflating apparatus according to claim 10, wherein the servomotor is attached to a pin which upon activation of the actuator is adapted to pierce the cylinder to release inflating product.

12. An electronically controlled inflating apparatus according to claim 10, wherein the servomotor is attached to a pin which upon activation of the actuator is adapted to open a valve of the cylinder to release inflating product.

13. An electronically controlled inflating apparatus according to claim 1, wherein the actuator upon activation triggers a chemical reaction to produce inflating product.

14. An electronically controlled inflating apparatus according to claim 1, comprising a manual activation handle having a manual activation circuit in electrical communication with the actuator, the manual activation circuit being in an open condition until a user applies a pulling force to the manual activation handle, such pulling force causing the activation circuit to be closed so as to activate the actuator.

15. An electronically controlled inflating apparatus for inflating an inflatable bladder with inflating product, the inflating apparatus comprising:
an actuator which upon activation is adapted to cause the inflatable bladder to be filled with inflating product;
a sensor assembly operatively associated with the actuator, the sensor assembly including a first pressure sensor and a second pressure sensor;
a water sensing assembly operatively associated with the first pressure sensor and the second pressure sensor, the water sensing assembly being configured to place the first pressure sensor and the second pressure sensor in a standby mode upon the detection of water by the water sensing assembly,
wherein the actuator is activated after the first and second pressure sensors have been placed in the standby mode and upon the first and second pressure sensors detecting a preset pressure.
